(19) United States
(12) Patent Application Publication
(10) Pub. No.: US 2013/0085936 A1
(43) Pub. Date: Apr. 4, 2013

(54) SECURE BILLING SYSTEM AND METHOD FOR A MOBILE DEVICE

(71) Applicants: Simon Law, Mississauga (CA); Michael Shvartsman, Miami, FL (US); Jim Brown, Toronto (CA); Jimmy Law, Mississauga (CA)

(72) Inventors: Simon Law, Mississauga (CA); Michael Shvartsman, Miami, FL (US); Jim Brown, Toronto (CA); Jimmy Law, Mississauga (CA)

(73) Assignee: XTREME MOBILITY INC., Toronto, ON (CA)

(21) Appl. No.: 13/581,189

(22) PCT Filed: Feb. 25, 2011
(86) PCT No.: PCT/CA11/00197

§ 371 Date: Dec. 6, 2012

(30) Foreign Application Priority Data
Feb. 26, 2010 (CA) 2692677

(51) Int. Cl. G06Q 20/14

(52) U.S. Cl. CPC G06Q 20/14; G06Q 20/322
USPC 705/40

(57) ABSTRACT

A system and method are provided for scheduling the payments of bills. An authorization server is provided to be in communication with one or more payment servers and a mobile device. The authorization server receives bills from a billing account, and each of the payment servers can make payments to the billing account. A mobile billing manager, residing on at least the mobile device, detects a new bill and then displays a graphical user interface (GUI) on the mobile device. Through the GUI, selection inputs are received, the selection inputs being associated with paying a first amount at a first date from a first payment account. Based on the payment schedule, the mobile billing manager, through the authorization server, instructs the payment server to make payments.

### TECHNICAL FIELD

The following relates generally to secure wireless billing and more specifically to a system and method in which a mobile device is used to authorize payments from one or more payment accounts to one or more billing accounts.

### DESCRIPTION OF THE RELATED ART

The wide spread use of credit-based purchases requires a user of a billing account to pay back the credited amount, or billed amount, at some future date after the purchase has taken place. A user may be an account holder of one, or typically, multiple billing accounts. Managing the payment of the billing accounts can be time consuming and cause inconvenience when managing several billing accounts.

Moreover, the billing entities who manage the billing accounts may find it difficult to contact and remind the user of billing payments. The billing entities may also be unaware of the user's financial status or the user's financial habits, such as incoming funds and other bill payments.

### BRIEF DESCRIPTION OF THE DRAWINGS

Embodiments will now be described by way of example only with reference to the appended drawings wherein:

FIG. 1 is a schematic diagram to illustrate a secure wireless billing system.

FIG. 2 is a block diagram of an example embodiment of a mobile device.

FIG. 3 is a block diagram illustrating example ones of the other software applications and components shown in FIG. 2.

FIG. 4 is a block diagram illustrating an example software application and component residing on an authorization server shown in FIG. 1.

FIG. 5 is a flow diagram for associating a billing account, payment account, user and mobile device identification.

FIG. 6 is a schematic block diagram of an example relationship between data types for each billing account at a billing server.

FIG. 7 is a schematic block diagram of an example relationship between various data types for each mobile device.

FIG. 8 is a flow diagram of an example mobile bill payment process.

FIG. 9 is a flow diagram, continuing from FIG. 8, of the mobile bill payment process.

FIG. 10 is a flow diagram, continuing from FIG. 9, of the mobile bill payment process.

FIG. 11 is a screen shot of an embodiment of a graphical user interface (GUI) for selecting bill payment options.

FIG. 12 is a screen shot of an embodiment of a GUI for selecting advanced bill payment options.

FIG. 13 is a screen shot of a specific embodiment of a GUI according the embodiment shown in FIG. 12.

FIG. 14 is a screen shot of an embodiment of a GUI for selecting bill scheduling options and default settings.

FIG. 15 is a screen shot of an embodiment of a GUI for selecting other ones of bill scheduling options and default settings.

FIG. 16 is a screen shot of an embodiment of a GUI for showing a notification for insufficient funds.

FIG. 17 is a screen shot of another embodiment of a GUI for showing a notification for insufficient funds.

FIG. 18 is a screen shot of an embodiment of a GUI for showing a notification for an incoming bill.

FIG. 19 is a screen shot of an embodiment of a GUI for showing a scheduled payment to be made ‘today’.

FIG. 20 is a screen shot of an embodiment of a GUI for showing options to a user to authorize a previously scheduled payment.

FIG. 21 is a flow diagram of an example process for estimating a billed amount on an upcoming bill.

FIG. 22 is a flow diagram of an example process for determining which purchases on a bill are likely incorrect.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

A billing account allows an account holder to purchase goods or services based on the account holder's promise to pay for these goods or services in the future. In one example of a billing account, the account holder is requested to pay a defined minimum portion of the bill before a due date. The account holder may choose to pay an amount higher than the minimum portion, such as for example, the entire amount owed. If the user does not pay the bill in full, the one who issues the billing account can choose to charge interest on the amount owed.

It can be appreciated that a billing account is different from other accounts (e.g. debit account, bank account) in that when a user purchases a good or a service, the user does not need to pay at the time of purchase in order to obtain the good or the service. In other words, the user may purchase a good or a service with the promise to pay later, and then at a later date, pay the required amount. Non-limiting examples of billing accounts are credit card accounts, phone bill accounts, mortgage accounts, car leasing accounts, and utility accounts.

In one example, a billing account typically operates by accumulating one or more purchases that the account holder has made. At a predetermined time, the billing account sends the account holder a bill for the accumulated purchases that have not yet been paid. Upon the account holder receiving the bill, the account holder may then decide whether or not to pay for at least a portion of the bill. The user may then access a bank account to request that a payment (e.g. at least the minimum portion of the bill) of funds be transferred from the bank account to the billing account. Thus, the user is required to manually access the bank account, specify the billing account, specify the amount to be transferred, and execute the transfer of funds. It can be readily understood that the user moves through several different steps, whereby the user enters data (e.g. bank account number, password, billing account number, amount to be transferred) at each step. This process takes time and may be subject to more error as the user enters data at each step.

Alternatively, in another example, a user may arrange for their bank account to make a scheduled payment of a predetermined amount to the billing account. The user, for example, may request the bank account to make a payment of $50 on the second day of every month to the billing account. In situations when the user has accumulated a bill of less than $50, then the user is overpaying. Furthermore, in situations where the user has accumulated a bill of more than $50, then the user would not be paying the full amount. It can thus be understood that the user would access the bank account to pay the difference in the amount of money, or to prevent overpayment.

In another example, the user may provide the bank account information to the billing account holder, such that the billing account is able to automatically withdraw the full payment amount from the bank account. An example of such a payment system may be referred to as a pre-authorized debit. However, this is undesirable since the billed amount may be incorrect. Billed amounts may be incorrect due to any number of reasons, including but not limited to fraud and clerical errors. Further, a user may be uncomfortable with providing a billing account holder with confidential information, such as the bank account information. Thus, it may be undesirable to establish a pre-authorized debit relationship between the billing account holder and the banking account.

A system is therefore provided to allow a mobile device to more easily coordinate and manage the payments of one or more bills.

In one aspect, a system and method for scheduling the payments of one or more bills is provided, comprising an authorization server in communication with one or more payment servers and a mobile device. The authorization server may be configured to receive one or more bills from a billing account, and the one or more payment servers are each configured to make one or more payments to the billing account. A mobile billing manager may reside on at least the mobile device, whereby the mobile billing manager may be configured to execute the following instructions: displaying a graphical user interface (GUI) on the mobile device to receive one or more selection inputs to activate and determine automatic payment settings associated with one or more payment accounts, one or amounts to be paid, and one or more respective payment dates associated with each of the one or more amounts to be paid; upon the mobile billing manager detecting the receipt of a bill, the mobile billing manager, through the authorization server, instructing the one or more payment servers to pay a first amount at a first predetermined date from a first payment account.

In another aspect of the system and method, the mobile billing manager may also reside on the authorization server. Further, upon detecting the receipt of a bill, the mobile billing manager on the authorization server may not communicate with the mobile device before instructing the one or more payment servers to automatically pay the first amount. The bill may comprise a total amount billed and a requested minimum amount to be paid by a due date. The GUI for the automatic payment settings may include an option for setting the first predetermined date to be on or before the due date and the first amount to be greater than or equal to the requested minimum amount. The GUI for the automatic payment settings may allow for a user to determine the maximum amount to be automatically paid in association with the bill. In another aspect, the automatic payment settings may be activated for a given range of dates. In another aspect, the mobile manager may also be configured to execute instructions for: determining the available amount of funds in the first payment account; determining if the available amount of funds are greater than the first amount and, if so, instructing the payment server to pay the first amount. In another aspect, the mobile billing manager may further instruct the one or more payment servers to pay a second amount at a second predetermined date from the first payment account or a second payment account. In another aspect, the mobile billing manager may further instruct the one or more payment servers to pay a second amount at a second predetermined date from the first payment account or a second payment account, and wherein the second amount is the balance of the total amount billed that is unpaid and the second date is after the first predetermined date. In another aspect, a first payment server is associated with the first payment account and a second payment server is associated with the second payment account. In another aspect, the second amount is scheduled to be paid on the second predetermined date from the second account.

A system and method are also provided for scheduling the payments of one or more bills comprising an authorization server in communication with one or more payment servers and a mobile device. The authorization server may be configured to receive one or more bills from a billing account, and each of the one or more payment servers configured to make one or more payments to the billing account. A mobile billing manager may reside on at least the mobile device, whereby the mobile billing manager may be configured to execute the following instructions: upon the mobile billing manager detecting a bill, displaying a graphical user interface (GUI) on the mobile device; receiving one or more selection inputs through the GUI associated with paying a first amount at a first predetermined date from a first payment account; and the mobile billing manager, through the authorization server, instructing the one or more payment servers to pay the first amount at the first predetermined date from the first payment account.

In another aspect, the bill may comprise at least any one of a new bill or an outstanding bill. In another aspect, the mobile billing manager may also reside on the authorization server. In another aspect, the bill may comprise a total amount billed and a requested minimum amount to be paid by a due date. In another aspect, the mobile billing manager may display an option box that is checked off when at least the requested minimum amount is scheduled to be paid on or before the due date. In another aspect, the mobile billing manager may also configured to execute the following instructions: through the GUI, the mobile billing manager displaying an option of whether or not to pre-authorize the authorization server to automatically instruct the one or more payment servers to pay the first amount; and, if the first amount is not pre-authorized, then on or before the first predetermined date, the mobile billing manager displaying on the mobile device a request for authorization to pay the first amount from the first payment account. In another aspect, the mobile billing manager may also be configured to execute instructions for: determining from the one or more payment servers the available amount of funds in the first payment account; determining if the available amount of funds are greater than the first amount and, if so, instructing the one or more payment servers to pay the first amount. In another aspect, if the available amount of funds are not greater than the first amount, then the mobile billing manager may display a notification that there are insufficient funds in the first payment account. In another aspect, the mobile billing manager may also be configured to execute instructions for: determining which one of the one or more payment accounts has available funds that are greater than the first amount; displaying on the mobile device a suggestion to pay the first amount from the one of the one or more payment accounts that has available funds greater than the first amount. In another aspect, the mobile billing manager is also configured to execute instructions for: receiving the one or more selection inputs through the GUI associated with paying a second amount at a second predetermined date from the first payment account or a second payment account; and, the mobile billing manager, through the authorization server, further instructing the one or more payment servers to pay the second amount at the second predetermined date from the first payment account or the second payment account. In another aspect, the mobile billing manager may also be configured to execute the following instructions: receiving the one or more selection inputs through the GUI associated with paying a second amount at a second predetermined date from the first payment account or a second payment account; the mobile billing manager, through the authorization server, further instructing the one or more payment servers to pay the second amount at the second predetermined date from the first payment account or the second payment account; and, upon receiving the one or more selection inputs associated with paying the first amount and the second amount, the mobile billing manager determining and displaying on the GUI whether or not at least the requested minimum amount is scheduled to be paid on or before the due date. In another aspect, the mobile billing manager may also be configured to execute the following instructions: through the GUI, the mobile billing manager displaying an option of whether or not to pre-authorize the authorization server to automatically instruct the one or more payment servers to pay the second amount; if the second amount is not pre-authorized, then on or before the second predetermined date, the mobile billing manager displaying on the mobile device a request for authorization to pay the second amount from the first payment account or the second payment account.

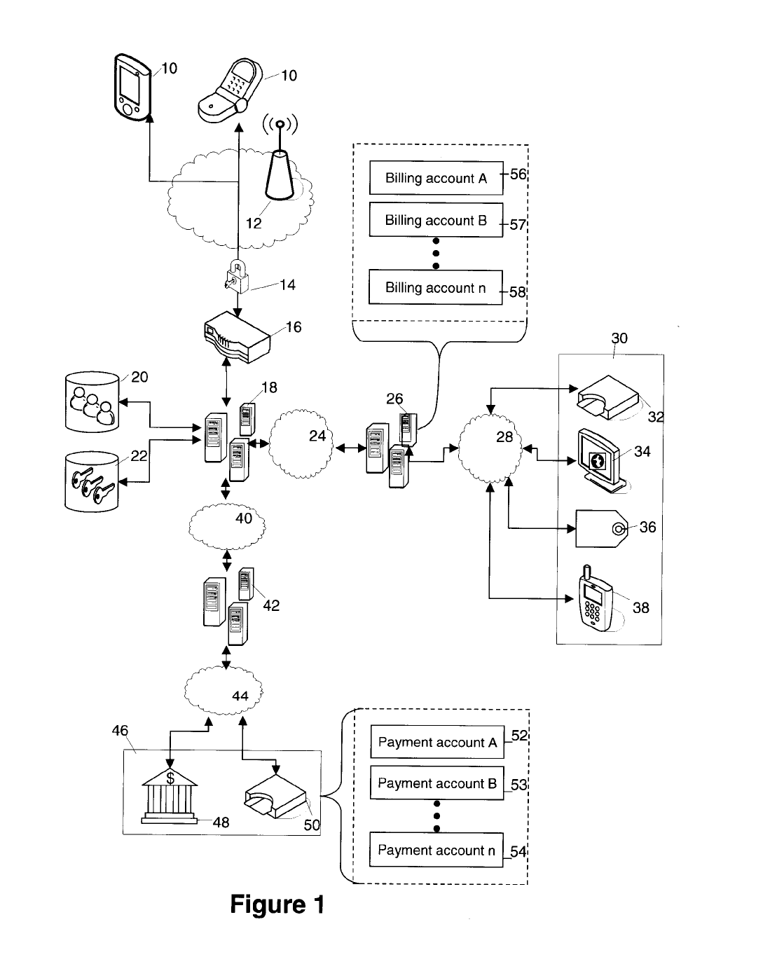

FIG. 1 shows a user's mobile device 10, an authorization server 18, a billing account server 26, and a payment account server 42. It can be appreciated that an example of a billing account server 26 is a credit card account server, and an example of a payment account server 42 is a bank account server. The servers are computing devices having memory for storing data and computer executable instructions. As discussed below, the mobile device 10 and the servers are in communication with one another.

The purpose of the billing account server 26 is to manage the billing accounts for a billing account system. In other words, the billing account server 26 interfaces with the billing account. It can be appreciated that the billing accounts may be in communication with or reside on the billing account server 26. A user may purchase a good or a service, thereby increasing a bill on the billing account. Such a purchase may be made using various devices 30 that include, but are not limited to, a magnetic swipe card 32, an internet web browser 34, a smart card 36, or an RFID-enabled device 38. It can be appreciated that any device for suitable for billing a user for purchasing a service or a good is applicable to the principles described herein. Each of the aforementioned devices, in addition to the authorization server 18, communicates with the billing account server 26 over a system-dependent billing account network 28 in order to access the billing accounts. As discussed above, billing accounts may be for any purpose. Other non-limiting examples of billing accounts include medical services, legal services, student loans and road toll services. It can also be appreciated that the purchase of a good or service may not use a device 30, and the billed amount may be captured using software suitable for interacting with the billing account server 26. Examples of one or more billing accounts are represented herewith as billing account A 56, billing account B 57 and billing account n 58.

Continuing with FIG. 1, the payment account server 42 provides an interface to a payment account entity 46 from which funds or value points can be obtained to deposit or transfer into the user's billing account. The payment account entity 46 may be a financial institution where the user holds a credit card account or bank account 48, or a separate prepaid system 50. It can be appreciated that payment account entities 46 include any type of account from which funds can be withdrawn. It can be appreciated that funds may be in the form of monies, points (e.g. AirMiles™), or other value reward systems. Examples of payment account entities include bank accounts, credit card accounts and PayPal™. Examples of one or more payment accounts are represented herewith as payment account A 52, payment account B 53 and payment account n 54.

In another embodiment of the system, although rare, the payment account entity 46 may be a separate application residing on the same server as the billing account and/or authorization servers, or a separate server residing within the same company or financial institution. For example, this can be dependant on whether the payment account server 42 resides with the same financial institution or organization as the billing account server 26. In other words, the functions of the payment account server 42 and authorization server 18 may reside on the same server; the functions of the billing account server 26 and authorization server 18 may reside on the same server; the functions of the payment account server 42 and billing account server 26 may reside on the same server; or, in yet another embodiment, the functions of all the servers (e.g. 18, 26, 42) may all reside on a common server. It can be appreciated that the payment account server 42 communicates with the payment account entity 46 over a system-dependent network 44.

The authorization server 18 manages the authorization used in the process of transferring monies from the payment server 42 to the billing server 26. The authorization server 18 can include one or more servers or mainframes connected together to handle high volumes of traffic and processing, and may also be responsible for authenticating the user and the user's activities between one or more of the user's billing accounts and one or more of the user's payment accounts. In addition, upon successful authentication, the authorization server 18 may be responsible for initiating a request to the payment account server 42 to obtain the desired amount of funds to be deposited in the user's billing account, then depositing those funds into the user's billing account via the billing account server 26.

For simplicity of language, the billing account server may be referred to as the billing server 26, and the payment account server may be referred to as the payment server 42. It can also be readily understood that there may be multiple billing servers 26 and multiple payment servers 42 in communication with the authorization server 18. For example, there may be a billing server specifically for a phone bill account, a billing server specifically for a road toll bill account, and a billing server specifically for a credit card bill account. There may also be a payment server specifically for a bank account, a payment server specifically for a credit card account, a payment server specifically for a pre-paid payment account. In other words, separate billing accounts and separate payment accounts may each have associated therewith separate billing servers 26 and separate payment servers 42, respectively.

The authorization server 18 includes a database that stores the account information of the system's users 20. This information is used to associate a request from a mobile device 10 with a user's billing account. It can also be used to authenticate a user's credentials in order to authorize payment requests. It is noted that the authorization server 18 can also forward requests for authentication to the billing server 26 or payment server 42 if needed. The authorization server 18 will also include the secure storage 22 of encryption keys and/or certificates used to create secure connections with the wireless devices.

The connections that are established between the authorization server 18 and the user's mobile device 10 are secured using encryption schemes 14. Using these security schemes 14 to secure the connection provides the benefits of privacy, authentication, message integrity and non-repudiation. Non-limiting examples of security schemes that can be used are symmetric-key encryption and asymmetric-key encryption. In another example embodiment of an encryption process, certain connections may be secured while others may not be secured. For example, an initiating message to establish a connection may not be encrypted, although a reply message may be encrypted.

Symmetric-key encryption is preferably used to secure the connection for the purposes of making deposit requests. For the symmetric-key encryption scheme, the mobile device 10 and the authorization server 18 may negotiate and agree upon a symmetric key and a unique device identifier before a request can take place. The device identifier is used to associate the symmetric key with the mobile device 10, so that the authorization server 18 will be able to differentiate and decrypt communications initiated by different mobile devices. The negotiated key can be generated using a combination of random values generated by both the mobile device 10 and the authorization server 18 and/or other known quantities.

A public-key encryption scheme is preferably used to secure the channel or connection between the mobile device 10 and the authorization server 18 so that the symmetric key can be negotiated. The mobile device 10 uses the public key to encrypt a negotiation initialization message. This message contains the mobile device-specific component of the negotiation as well as the user credentials. The authorization server 18 decrypts this message and extracts the user credentials. The credentials are then validated by one or more of the authorization server 18, the billing account server 26 and the payment account server 42. Once the identity of the user has been confirmed, the authorization server 18 returns the server-specific component of the negotiation data as well as a unique device identifier to the mobile device 10 over the aforementioned public-key encrypted channel. Now both the mobile device 10 and authorization server 18 hold the data needed to create the symmetric key, and the mobile device 10 has obtained a unique device identifier.

All request messages will contain the aforementioned unique device identifier as well as a unique sequence number to identify the specific transaction. This will assist in nullifying replay attacks. As in the original symmetric-key negotiation process, the user will also supply credentials to authenticate himself or herself to the authorization server 18 on each request. The credentials will be sent over the secure channel to be verified by the authorization server 18. As disclosed previously, this channel is encrypted by the pre-established symmetric key. The symmetric-key encryption scheme is ideal for communicating over a channel such as, for example, SMS/EMS/MMS. Improper encryption or incorrect credentials would cause the request to be aborted.

On the mobile device 10, software is used to send/receive messages to/from the authorization server 18. This software is also capable of using various security schemes and communication channels.

In the case where some of the user's credentials are stored within the mobile device 10, the credentials will be stored within the mobile device's secure storage. In the absence of such secure storage, the credentials can be encrypted using public-key encryption and stored in that encrypted form. This will ensure that even if a user's mobile device 10 is stolen, or even if the device's symmetric key is compromised, the user's credentials remain safe from theft.

Similarly, encryption keys and/or user account information stored on the authorization server 18 can be protected by storing the data in secure storage.

In order to protect the integrity of the application, it can be delivered to the customer through a secure channel protected by a public-key encryption scheme such as Secure Sockets Layer (SSL) or Transport Layer Security (TLS). The precise SSL and TLS protocols will not be described in detail herein, since they are well known protocols for those skilled in the art. Once the application is obtained, the customer is simply expected to follow the instructions and install it.

Continuing with FIG. 1, the wireless gateway 16 is an entity that bridges the authorization server 18 with the wireless network 12. It translates communication requests and information into wireless network protocols so that the mobile device 10 can communicate with the authorization server 18. Typical wireless gateways are short message service centers (SMSC), multimedia message service centers (MMSC), gateway GPRS (General Packet Radio Service) service nodes (GGSN), and CDMA2000 (Code Division Multiple Access) Packet Data Serving Nodes (PDSN). For instance, a mobile device 10 will package 140 bytes into a message that can be received by the SMSC and forwarded to the administrating server. The authorization server 18 can also use SMS to send a message back to the mobile device 10 through the SMSC. Alternatively, the system can use a packet based technology using the GGSN or CDMA2000 PDSN. Typically, GPRS or CDMA2000 would be used for connection-oriented connections while short message service/enhanced message service/multimedia message service (SMS/EMS/MMS) would be used for connectionless communication. Other networks 12 applicable to the principles described herein comprise: the Groupe Special Mobile or the Global System for Mobile Communications (GSM), the existing and upcoming third-generation (3G) and fourth generation (4G) networks like EDGE, UMTS and HSDPA, LTE, Wi-Max etc, the Mobitex Radio Network (“Mobitex”), and the DataTAC Radio Network (“DataTAC”). The system contemplates a method to operate on either connection-oriented or connectionless protocols or both.

The mobile device 10 is an entity that allows the user to initiate deposit requests. The mobile device should be computationally capable of creating an encrypted secure connection within a reasonable time. In the preferred embodiment, the mobile device 10 is also able to store an application. This application will be responsible for securely storing certificates or encryption keys, or both, and user information. In one example, the stored information allows the user to initiate a payment request, set up the secure connection to the authentication server 18, transmit a payment request, receive the payment request response from the authentication server 18, and display the response to the user. Typically the mobile device 10 is a mobile cellular phone, a wirelessly enabled personal digital assistant (PDA), and/or a mobile cellular capable personal digital assistant such as a smart-phone. Other examples of mobile devices include desktops, laptops, netbooks and other wireless devices.

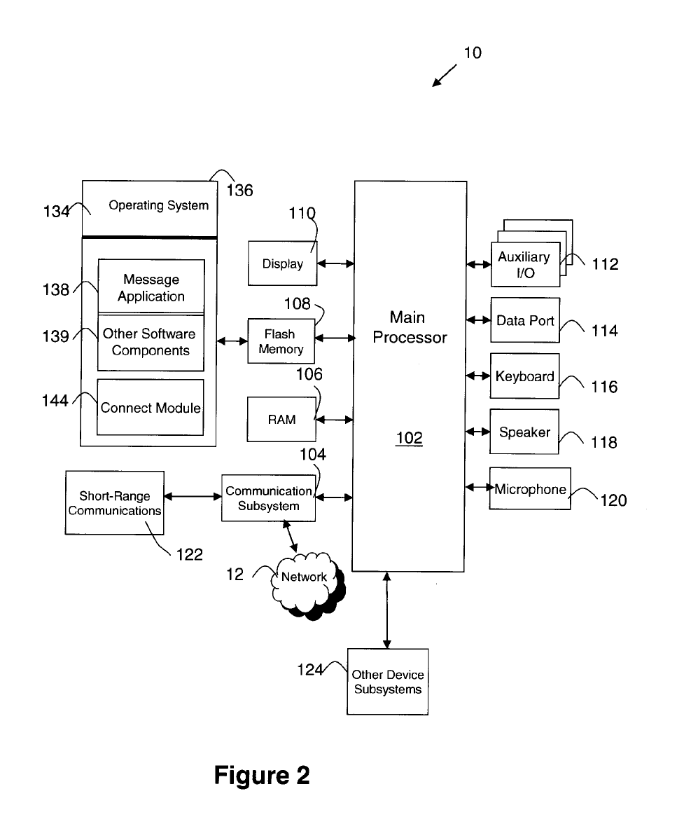

The mobile device 10 can be a two-way communication device with advanced data communication capabilities including the capability to communicate with other mobile devices 10 or computer systems through a network of transceiver stations. The mobile device 10 may also have the capability to allow voice communication. Depending on the functionality provided by the mobile device 10, it may be referred to as a data messaging device, a two-way pager, a cellular telephone with data messaging capabilities, a wireless Internet appliance, or a data communication device (with or without telephony capabilities). The mobile device 10 can also be one that is used in a system that is configured for continuously routing all forms of pushed information from a server to the mobile device 10. One example of such a system will now be described making reference to FIG. 2.

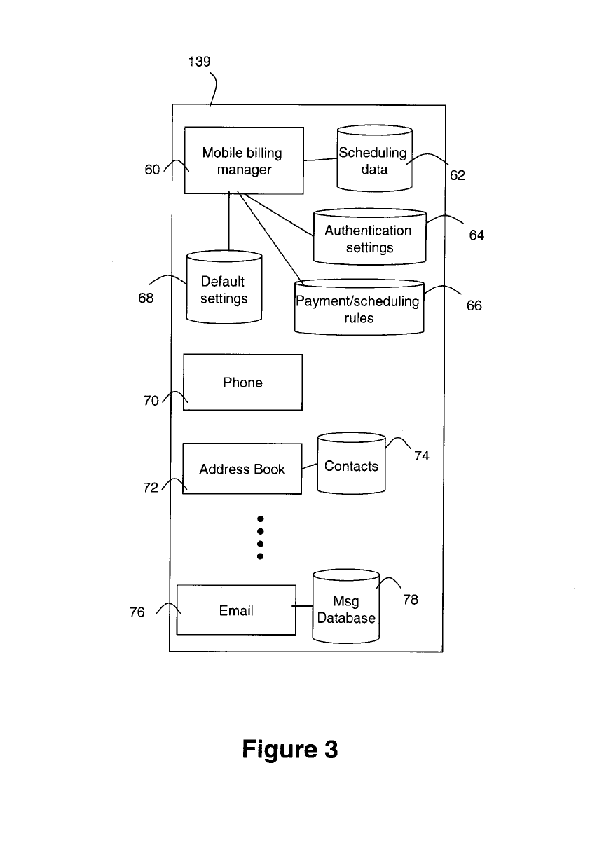

An exemplary configuration for the mobile device 10 is illustrated in FIG. 2 and FIG. 3. Referring first to FIG. 2, shown therein is a block diagram of an exemplary embodiment of a mobile device 10. The mobile device 10 comprises a number of components such as a main processor 102 that controls the overall operation of the mobile device 10. Communication functions, including data and voice communications, are performed through a communication subsystem 104. The communication subsystem 104 receives messages from and sends messages to a wireless network 12. In this exemplary embodiment of the mobile device 10, the communication subsystem 104 is configured in accordance with the CDMA, GSM and GPRS standards, which are used worldwide. Other communication configurations that are equally applicable are the 3G and 4G networks discussed above. New standards are still being defined, but it is believed that they will have similarities to the network behaviour described herein, and it will also be understood by persons skilled in the art that the embodiments described herein are intended to use any other suitable standards that are developed in the future. The wireless link connecting the communication subsystem 104 with the wireless network 12 represents one or more different Radio Frequency (RF) channels, operating according to defined protocols specified for GSM/GPRS and CDMA communications.

The main processor 102 also interacts with additional subsystems such as a Random Access Memory (RAM) 106, a flash memory 108, a display 110, an auxiliary input/output (I/O) subsystem 112, a data port 114, a keyboard 116, a speaker 118, a microphone 120, a GPS receiver 121, short-range communications 122, and other device subsystems 124. As will be discussed below, the short-range communications 122 can implement any suitable or desirable device-to-device or peer-to-peer communications protocol capable of communicating at a relatively short range, e.g. directly from one device to another. Examples include Bluetooth®, ad-hoc WiFi, Near Field Communication (NFC), infrared, or any “long-range” protocol re-configured to utilize available short-range components. It will therefore be appreciated that short-range communications 122 may represent any hardware, software or combination of both that enable a communication protocol to be implemented between devices or entities in a short range scenario.

Some of the subsystems of the mobile device 10 perform communication-related functions, whereas other subsystems may provide “resident” or on-device functions. By way of example, the display 110 and the keyboard 116 may be used for both communication-related functions, such as entering a text message for transmission over the network 12, and device-resident functions such as a calculator or task list.

The mobile device 10 also includes an operating system 134 and software components 136 to 146 which are described in more detail below. The operating system 134 and the software components 136 to 144 that are executed by the main processor 102 are typically stored in a persistent store such as the flash memory 108, which may alternatively be a read-only memory (ROM) or similar storage element (not shown). Those skilled in the art will appreciate that portions of the operating system 134 and the software components 136 to 144, such as specific device applications, or parts thereof, may be temporarily loaded into a volatile store such as the RAM 106. Other software components can also be included, as is well known to those skilled in the art.

The subset of software applications 136 that control basic device operations, including data and voice communication applications, may be installed on the mobile device 10 during its manufacture. Software applications may include a message application 138 and a connect module 144. A message application 138 can be any suitable software program that allows a user of the mobile device 10 to send and receive electronic messages, wherein messages are typically stored in the flash memory 108 of the mobile device 10. A connect module 144 implements the communication protocols that are required for the mobile device 10 to communicate with the wireless infrastructure and any server, such as an enterprise system, that the mobile device 10 is authorized to interface with.

Other types of software applications or components 139 can also be installed on the mobile device 10. These software applications 139 can be pre-installed applications (i.e. other than message application 138) or third party applications, which are added after the manufacture of the mobile device 10. Examples of third party applications include games, calculators, utilities, etc. The additional applications 139 can be loaded onto the mobile device 10 through at least one of the wireless network 20, the auxiliary I/O subsystem 112, the data port 114, the short-range communications subsystem 122, or any other suitable device subsystem 124.

The data port 114 can be any suitable port that enables data communication between the mobile device 10 and another computing device. The data port 114 can be a serial or a parallel port. In some instances, the data port 114 can be a USB port that includes data lines for data transfer.

For voice communications, received signals are output to the speaker 118, and signals for transmission are generated by the microphone 120. Although voice or audio signal output is accomplished primarily through the speaker 118, the display 110 can also be used to provide additional information such as the identity of a calling party, duration of a voice call, or other voice call related information.

For composing data items, such as e-mail messages, for example, a user or subscriber could use a touch-sensitive overlay (not shown) on the display 110 that is part of a touch screen display (not shown), in addition to possibly the auxiliary I/O subsystem 112. The auxiliary I/O subsystem 112 may include devices such as: a mouse, track ball, infrared fingerprint detector, or a roller wheel with dynamic button pressing capability. A composed item may be transmitted over the wireless network 12 through the communication subsystem 104.

FIG. 3 shows an example of the other software applications and components 139 that may be stored on and used with the mobile device 10. Only examples are shown in FIG. 3 and such examples are not to be considered exhaustive. In this example, a mobile billing manager 60, phone application 70, address book 72 and message or email application 76 are shown to illustrate the various features that may be provided by the mobile device 10. The email application 76 stores or otherwise has access to a message database 78 for storing incoming and outgoing messages as well as those stored in various folders. It will be appreciated that the various applications may operate independently or may utilize features of other applications. For example, the phone application 70 and email application 76 may use the address book 72 for contact details obtained from a list of contacts 74.

The mobile billing manager application 60 allows a user to exchange data, including commands and authorization information, with the authorization server 18. The mobile billing manager 60 also allows a user to schedule bill payment activities. Further details of the operation of the mobile billing manager 60 are provided below. Several databases are in communication with the mobile billing manager 60, including a scheduling database 62, authentication settings database 64, payment/scheduling rules database 66, and default settings database 68. The scheduling database 62 stores or provides, or both, a schedule of the bill payment activities. The authentication settings database 64 stores or provides, or both, data related to authenticating the user when carrying out bill payment activities. Examples of such authentication data may include encryption keys, digital signatures, passwords, bank account information, credit card account information, encryption schemes, etc. The payment/scheduling rules database 66 stores or provides, or both, rules for carrying out bill payment activities as well the scheduling of the bill payment activities. The default settings database 68 stores default settings for carrying out the bill payment activities. It can be appreciated that the default settings may be customized to meet the user's preferences.

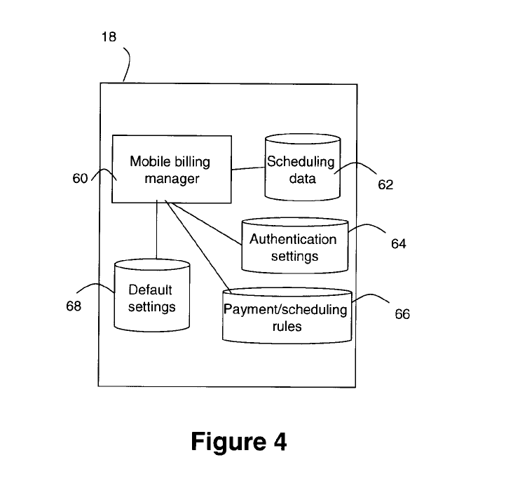

In another embodiment, shown in FIG. 4, the mobile billing manager 60, the scheduling database 62, the authentication settings database 64, the payment/scheduling rules database 66, and the default settings database 68 may reside on the authorization server 18. It may be preferable to store the databases 62, 64, 66, 68 on the authorization server 18 in order to reduce the amount of memory resources used on the mobile device 10. In this way, the mobile device 10 would communicate with the authorization server 18 to retrieve information needed to schedule the payment of bills. It can be understood that certain functionalities of the billing manager 60 may still reside on the mobile device 10, such as functions for displaying graphical user interfaces (GUIs).

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of any one of the servers or mobile devices or accessible or connectable thereto. Any application or module herein described may be implemented using computer readable/executable instructions that may be stored or otherwise held by such computer readable media.

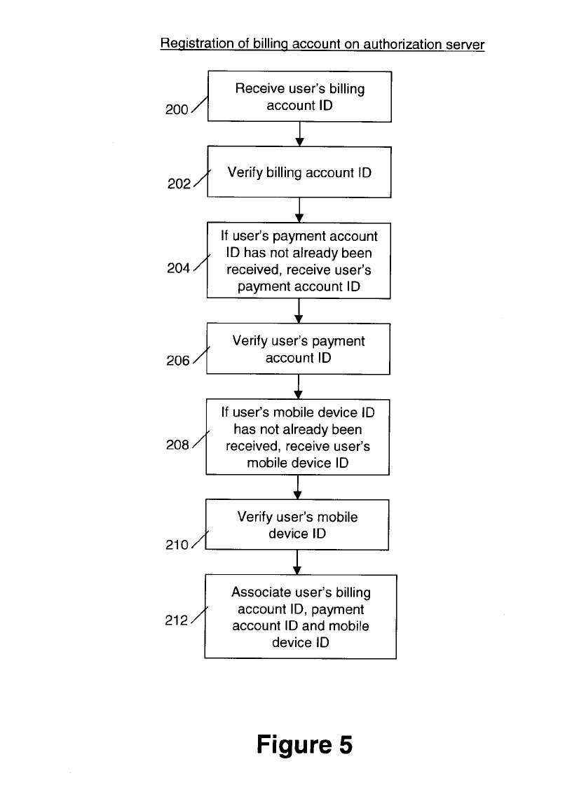

Turning to FIG. 5, an example method of registering a billing account with the authorization server 18 is provided. At block 200, the authorization server 18 receives the user's billing account identification associated with the user's billing account. The billing account ID may be provided to the authorization server 18 from the user, the billing account issuer or billing server 26, or a third party. Preferably, the authorization server 18 will verify the billing account identification, for example with the user or with the billing account issuer or billing server 26 (block 202). The authorization server 18 may or may not have already received or registered at least one payment account associated with the user. If not, then the authorization server 18 receives the user's payment account identification at block 204. The payment account identification may be provided to the authorization server 18 from the user, or the payment account entity 46, or a third party. Preferably, at block 206, the payment account identification is verified by the user or the payment account entity. The authorization server 18 may or may not have already received or registered at least one mobile device identification account associated with the user. If not, then the authorization server 18 receives the user's mobile device identification at block 208. The mobile device identification may be provided to the authorization server 18 from the user or a third party. Preferably, at block 210, the mobile device identification is verified by the user. After the authorization server 18 has received the billing account identification, the payment account identification and the mobile device identification, and has preferably verified each, then the authorization server 18 associates the three identifications with each other. In this way, when a bill is issued from the bill account issuer or billing server 26, the authorization server 18 is able contact the appropriate mobile device 10 with a bill notification. Further, through the mobile device 10, the user can schedule a payment to be made from a payment account to the billing account.

It can be appreciated that mobile device identification can be any data that allows the authorization server 18 to identify and contact a mobile device 10. Non-limiting examples of mobile device identification include a cell phone number, a peer-to-peer personal identification number, an email address, an internet protocol address, or a user name.

In another aspect of the system, the user may choose to pre-authorize access between the authorization server 18 and one or more payment servers 42. Pre-authorizing access advantageously allows the authorization server 18 to retrieve confidential payment account information from a payment server 42 and command the payment server 42 to carry out payment account activities. The authorization server 18 will typically carry out these actions based on user commands sent through the mobile device 10, or based on pre-defined rules at the authorization server 18, or both. By pre-authorizing access, the user does not need to provide authorization information at each instance when the authorization server 18 attempts to access the payment server 42. This has the perceived advantage of saving time for the user, reducing data entry error, and increasing security. It can be appreciated that entering confidential data repeatedly at the mobile device 10 may increase the risk that the confidential data may be copied by an attacker. It is noted however, that pre-authorization is an optional process, and that the mobile managements of one or more bills may still be implemented without pre-authorization.

In an example of a pre-authorization process, not shown, the authorization server 18 receives pre-authorization information and personal identification information from the user. The pre-authorization information may include, for example, the payment account identification (e.g. bank account number, credit card number) and security credentials (e.g. bank account password, credit card security number). The personal identification information may include the user's full name, birth date, and home address. The authorization server 18 then contacts the payment server 42 associated with the payment account provided by the user. Based on an exchange of information between the authorization server 18 and the payment server 42, the authorization server 18 and the payment server 42 determine if the pre-authorization information and personal identification (hereon simply referred to as user credentials), are correct. If the user credential provided are correct, the authorization server 18 securely stores the user credentials within a database in the authorization server 18. Alternatively, although not shown, partial of the user credentials may be stored on mobile device 10 for distributed security. In other words, where a first part of the user credentials are stored on the mobile device 10 and a second part of the user credentials are stored on the authorization server 18, the authorization server 18 must obtain the first part of the user credentials from the mobile device 10 in order to access the payment server 42.

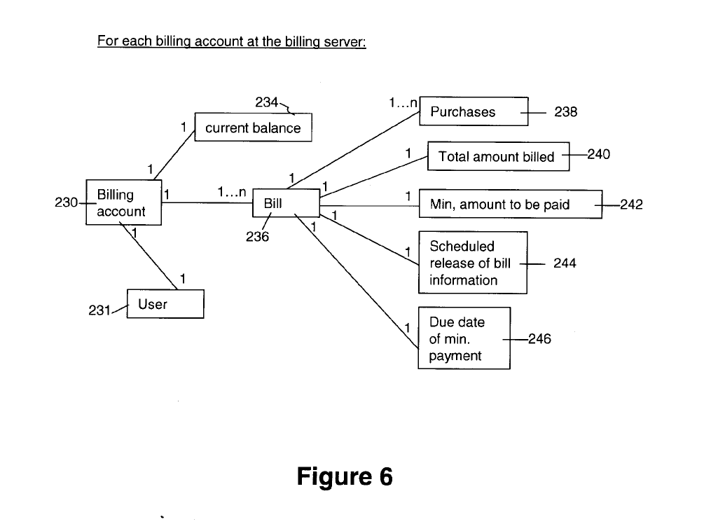

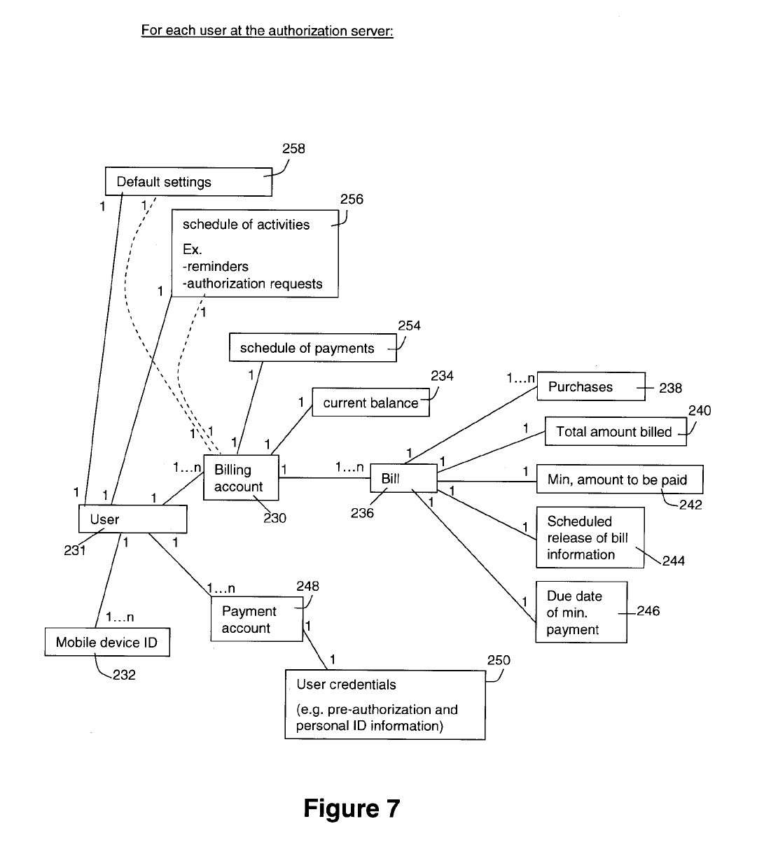

Turning to FIG. 6, a schematic is provided showing an example of relationships between data fields in a billing server 26, or in a database associated with the billing server 26. It can be appreciated that a billing server 26 may hold multiple billing accounts, each billing account associated with a user or an account holder. For example, in a billing server 26 for cell phone bills, there is a separate billing account 230 for each cell phone user. As described earlier in the registration process (see FIG. 5), each billing account 230 has associated a user or user account 231, as shown by the one-to-one relationship in FIG. 6. The user account 231 is also herein referred to as the user 231. Associated with each billing account 230 is also a current balance 234, also shown as a one-to-one relationship. It can be appreciated that each billing account 230 may be associated with multiple bills 236, as illustrated herein with the one-to-many relationship. For example, a cell phone billing account may be associated with multiple monthly bills that are issued on a monthly basis and may accumulate over time. In FIGS. 6 and 7, the one-to-many relationship is symbolically represented with the ‘1’ on a first end of a relationship line and with ‘1 . . . n’ on the second end of the relationship line. For each bill 236, there may be one or more purchases 238. Each bill 236 may also include the total amount billed 240, the minimum amount of funds to be paid 242, the scheduled release date of the bill to the user 244, and the due date for which the user is requested to pay the minimum amount 246. It can be appreciated that the data fields and relationships shown in FIG. 6 are exemplary, and that other data fields and configurations of those relationships may exist.

Turning to FIG. 7, a schematic showing the relationship between exemplary data fields in an authorization server 18 is provided. It can be appreciated that the authorization server 18 may manage the billing for multiple users, wherein each user 231 may be associated with one or more mobile device identifications 232. For example, a user may have multiple mobile devices which each run the mobile billing manager 60. In another example, a husband and a wife may register as a single user (e.g. a user called the “the Smiths”) whereby the husband may have his own mobile device ID and the wife may have her own mobile device ID. The billing system allows for either the husband or the wife to make payments for their bills using any one of their mobile devices 10. The user 231 is also associated with one or more payment accounts 248 and one or more billing accounts 230. As described earlier, the authorization server 18 may be in communication with multiple billing servers 26 and multiple payment servers 42.

Continuing with FIG. 7, for each user 231 there are one or more associated billing accounts 230, whereby each billing account 230 is associated with the current balance 234, one or more bills 236, purchases 238, the total amount billed 240, etc. This corresponds with the billing account data structure described above with respect to FIG. 6. The billing account data is provided to the authorization server 18 by the billing server 26. In addition, there is associated with each billing account 230 a schedule of payments 254. The schedule of payments 254 is determined at least in part by the user, or the mobile billing manager application 60, while typically taking into account a number of factors, such as for example the due date of the minimum payment 246.

Also associated with each user 231 are one or more payment accounts 248. Associated with each payment account 248 is preferably, although not necessarily, a one-to-one relationship is a set of user credentials 250, which may comprise any one of pre-authorization and personal identification data. An example process of providing user credentials 250 was described above with respect to FIG. 5.

Continuing with FIG. 7, each user 231 may be associated with a schedule of activities 256 that canvasses one or more of the billing accounts 230. Examples of scheduled activities include reminders for payments to be made, authorization requests from the authorization server 18, and alerts of insufficient funds in specified payment accounts 248. Also associated with each user 231, in a one-to-one relationship, may be a listing of default settings 258. The listing of default settings 258 may include, for example, the currency of the money or value points and whether pre-authorization is preferred. The default settings 258 are described in further detail below. In another embodiment, as shown by the dotted relationship lines, the schedule of activities 256 or the default settings 258, or both, may be associated with each separate billing account 230. In other words, each billing account 230 may have an associated default setting 258 and an associated schedule of activities 256.

It can be readily understood that in another embodiment, the data structure shown in FIG. 7 may reside on both the user's mobile device 10 and the authorization server 18, or in the alternative, only on the mobile device 10. In yet another embodiment, part of the data structure, such as the payment account 248 and user credentials 250, may reside on the mobile device 10, while the other part resides on the authorization server 18. The perceived advantages for storing parts of the data structure on the mobile device 10 are for security purposes. There may also be perceived advantages for storing all the data on the authorization server 18 for centralized and increased security, as well reducing data storage and processing load on the mobile device 10. In another perspective, there may be advantages for storing the scheduling activities 256, schedule of payments 254, and default settings 258 on the mobile device 10, since these data require interaction with the mobile device 10. Thus, storing such data on the mobile device 10 advantageously reduces the amount of data transmitted between the mobile device 10 and the authorization server 18. It can be appreciated that various configurations of the organization and storage of data are contemplated by the billing system and method described herein.

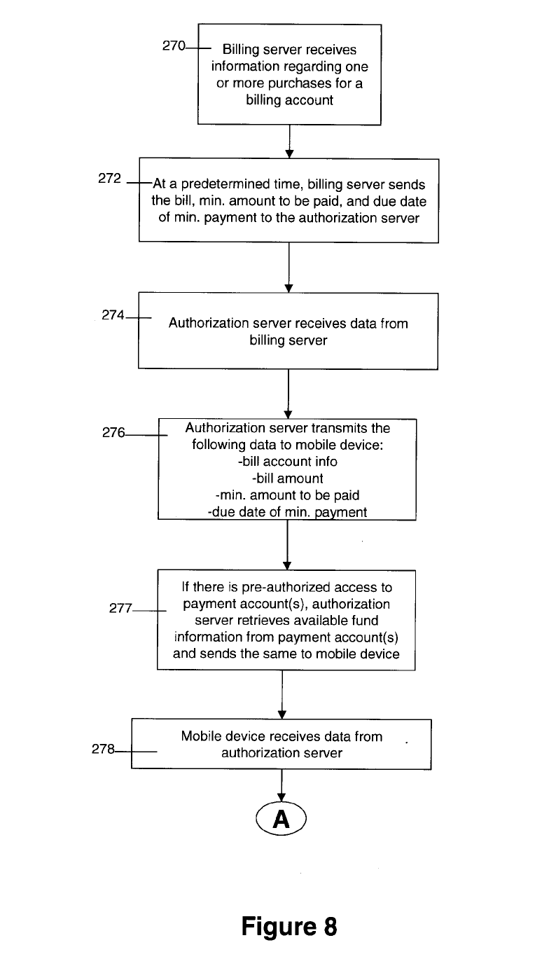

Turning to FIGS. 8 to 10, a process for managing bills using a mobile device 10, or number of computer executable instructions for implementing the process, is provided. In FIG. 8, at block 270, the billing server 26 receives information regarding one or more purchases for a billing account. At a pre-determined time (e.g. on a monthly basis), the billing server 26 sends the bill 236 to the authorization server 18. The bill 236 may for example include the corresponding purchases 238, total amount billed 240, minimum amount to be paid 242, scheduled release date of the bill 244, and the due date of the minimum payment 246 (block 272). The bill 236 is received by the authorization server 18 (block 274) and may store the billing data before transmitting the some or all of the billing data to the mobile device 10 (block 276). If the authorization server 18 has pre-authorized access to one or more of the user's payment accounts, or payment servers 42 thereof, the authorization server 18 may retrieve the available funds in the one or more payment accounts and send the same information to the mobile device 10 (block 277). By notifying the user of the available funds in the one or more payment accounts, the user or the mobile billing manager 60 may better decide from which payment accounts funds should be withdrawn to pay the bills. The authorization server 18 determines which mobile device 10 to contact using the mobile device identification 232. At block 278, the mobile device 10 receives the bill 236, as well as any other data, from the authorization server 18.

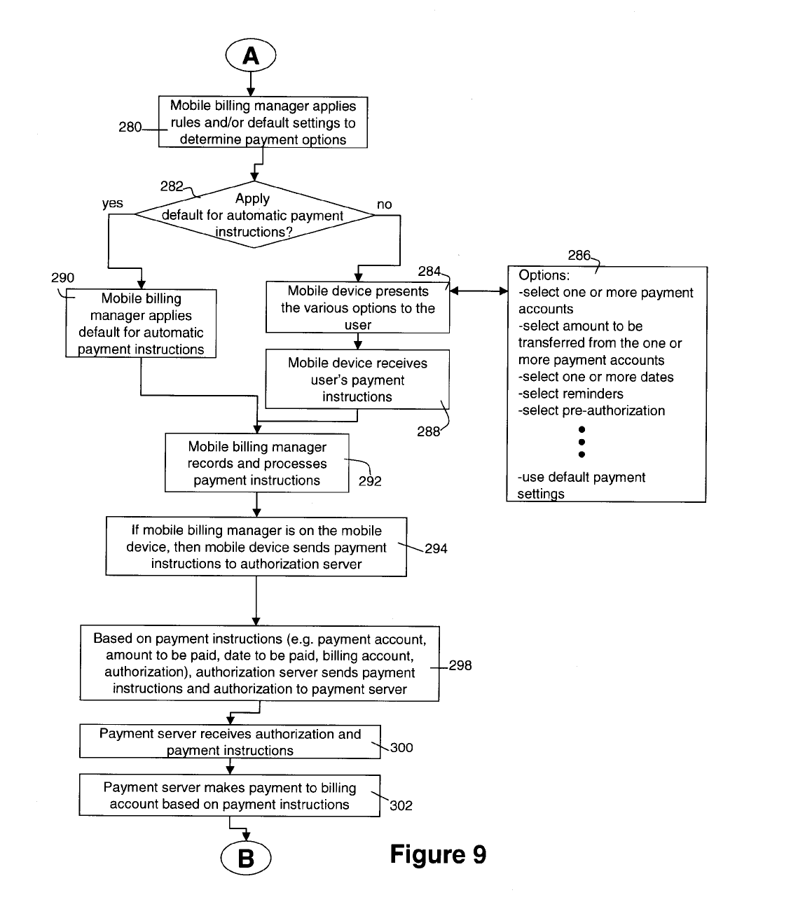

Turning to FIG. 9, which continues from FIG. 8 (e.g. block 278 flows to block 280), the mobile billing manager 60 applies rules or default settings to determine payment options (block 280). As described above, the mobile billing manager 60 and the databases 62, 64, 66, 68 may reside on the authorization server 18, the mobile device 10, another server, or distributed across a combination thereof. The payment/scheduling rules are stored in the payment/scheduling rules database 66. The default settings are stored in the default settings database 68. Non-limiting examples of payment/scheduling rules include the following:

| | |
|---|---|
| Rule 1 | If there are insufficient funds in a payment account, suggest another |
| | payment account. |
| Rule 2 | Based on patterns of incoming funds into the payment account, if there are |
| | currently insufficient funds, suggest user to schedule a pre-authorized |
| | payment one day after the expected date of the incoming funds. |
| Rule 3 | If there are outstanding bills, alert user schedule the payment of outstanding |
| | bills first. |
| Rule 4 | If user schedules minimum payment (or more) after the due date to pay the |
| | minimum amount, alert user and suggest to schedule payment on or before due |
| | date. |
| Rule 5 | If user does not pre-authorize access to payment server, and user has |
| | scheduled a future payment date, then send a reminder to user on a |
| | scheduled payment date requesting authorization. |
| Rule 6 | If service will be cancelled on a certain date due to insufficient payment to |
| | billing account, then send a message to the user some time (e.g. one week, |
| | one day) before the certain date to notify the user of pending service |
| | cancellation, the certain date, and amount of payment required to avoid |
| | service cancellation. |
| Rule 7 | If interest on current balance is applied at a certain date, then send a |
| | message to the user before the certain date to notify of the certain date, the |
| | interest rate, and the interest amount. |
| Rule 8 | If the user pays before a certain date, then apply a discount to the billed |
| | amount. |

It can be readily understood that there may be any number or type of rules that can be enabled or disabled by the user.

The default settings at the mobile billing manager 60 may include which payment accounts are to be displayed (if the user has indicated more than one payment account), the currency of the bills, the payment format (e.g. percent of bill, or dollar amount), pre-authorized payments, reminder notifications, and other bill payment display and function settings.

One of the default settings is to whether or not automatic payment instructions have been enabled (block 282). Automatic payment instructions, for example, include commands for the payment server 42 to pay at least the minimum amount (e.g. the minimum amount, or the total bill amount) to the billing account or billing server 26 issuing the bill. It can be appreciated that pre-authorization from the user is given beforehand, so that when the bill is sent to the authorization server 18, the user is not notified. Rather, based on the default setting for automatic payment, the mobile billing manager 60, without notifying the user, automatically authorizes and schedules the payment of the bill. Therefore, at block 282, if automatic payment instructions are enabled, then the mobile billing manager 60 applies the automatic payment instructions (block 290). The mobile billing manager 60 then records and processes the payment instructions (block 292).

However, if the automatic payment instructions are not enabled by the user, then the mobile billing manager 60, through the mobile device 10, presents various payment and scheduling options to the user (block 284). Non-limiting examples of the options are shown in block 286. It can be appreciated that the mobile billing manager 60 will present the options to the user through a GUI on the mobile device's display 110. The options may include: selecting one or more payment accounts (e.g. payment account A 52, payment account B 53, payment account C 54); selecting the amount to be transferred from each of the one or more payment accounts; selecting one or more data for the money or funds to be transferred from the payment account to the billing account; selecting reminders to pay later; selecting pre-authorized payment allowing the authorization server 18 to automatically make a payment at later date; and, using default payment settings, which may be a combination of one or more options that have been previously described.

Based on the user's selections, the mobile device 10 receives the payment instructions from the user (block 288). The mobile billing manager 60 then records and processes the payment instructions (block 292). The processing of the payment instructions may include retrieving the user's credentials, or parts of the user's credentials that are stored on the mobile device 10, needed to access the payment account. The processing of the payment instructions may also include encrypting the payment instructions and any confidential information in order to securely send the payment instructions.

At block 294, if the mobile billing manager 60 resides on the mobile device 10, then the mobile device 10 sends the payment instructions to the authorization server 18. The mobile device 10 may also send the user's credentials associated with a payment account to the authorization server 18, if the authorization server 18 does not have such user's credentials. However, if the user has not provided any payment instructions to the mobile device 10, and the payment instructions are automatically generated by the mobile billing manager 60 residing on the authorization server 18, then it can be appreciated that the authorization server 18 contains the payment instructions. In general, the authorization server 18 should receive the payment instructions processed by the mobile billing manager 60, whereby the mobile billing manager 60 and the databases 62, 64, 66, 68 may reside on the authorization server 18, the mobile device 10, another server, or distributed across a combination thereof.

At block 298, based on the payment instructions, the authorization server 18 sends instructions and authorization information to the payment server 42. As discussed above, the payment instructions may include the payment account, the amount of money or funds to be paid from the payment account to a specified billing account, and the date at which the payment is to take place. The authorization server 18 sends instructions to the payment server 42, instructing the payment server 42 to pay a certain amount of money to a specified billing account, and to make such payment on a certain date. If the authorization server 18 has not already been pre-authorized to access the payment server 42, then the authorization server 18 sends the user's credentials to the payment server 42. The user's credentials allow the payment server 42 to authenticate the authorization server's ability to act on behalf of the user, as described earlier.

It can be appreciated that the payment server 42 may receive instructions from the authorization server 18 to make a payment on the predetermined date. In other words, the authorization server 18 may send instructions on the predetermined date to the payment server 42 to make a payment on the same day. In another embodiment, the authorization server 18 may send payment instructions to the payment server 42 at some date before the predetermined date, such that when the predetermined date arrives, the payment server 42 executes the instructions for payment. It can therefore be understood that the payment server 42 may have a scheduling application to manage the dates of when to make payments, based on the payment instructions provided by the authorization server 18.

Continuing with FIG. 9, the payment server 42 receives the payment instructions and, optionally, the authorization or the user's credentials from the authorization server 18 (block 300). The payment server 42 then makes the payment to the billing account, usually through the billing server 26, based on the payment instructions (block 302).

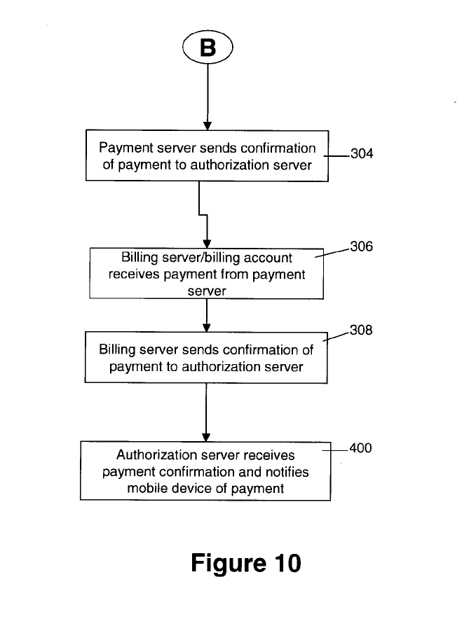

Turning to FIG. 10, which continues from FIG. 9, after block 302, the payment server 42 may send confirmation of payment to the authorization server 18 (block 304). In addition, or in the alternative, when the billing server 26 or billing account receives the payment from the payment server 42 (block 306), the billing server 26 may send confirmation of payment to the authorization server 18 (block 308). After the authorization server 18 receives payment confirmation from either the payment server 42 or billing server 26, or both, the authorization server 18 may send a confirmation of the completed bill payment to the mobile device 10, for the user's reference (block 400).

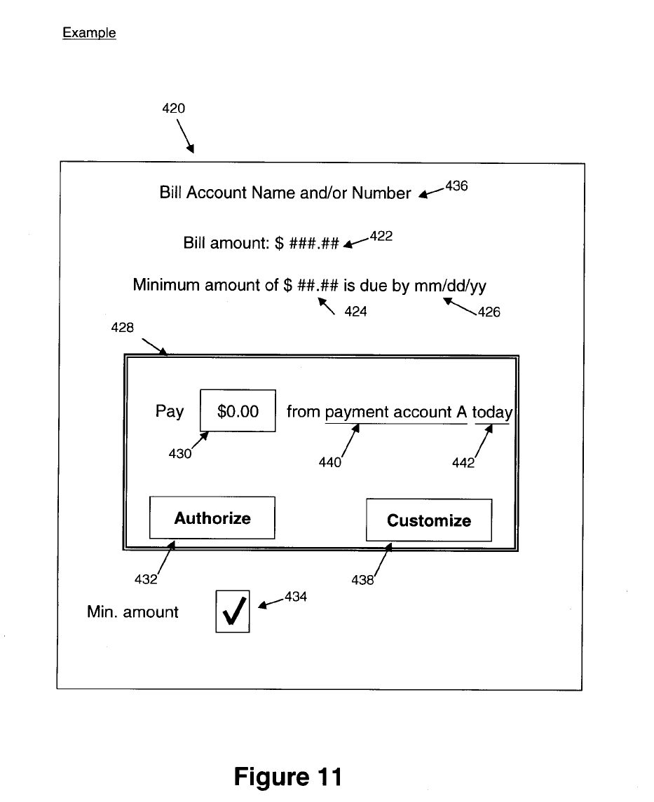

Turning to FIG. 11, an example of a GUI screen 420 is shown, which is provided by the mobile billing manager 60 and displayed on the mobile device 10. It can be appreciated that such a screen 420 may be shown at block 284, when the mobile device 10 presents payment options to the user as described earlier. The example screen 420 presents several payment options to the user, although many of the options may be customized ahead of time for the user's convenience as will be explained further below. The screen 420 displays the name or number, or both, of the billing account 436 (e.g. ABC Credit Card—Account No. 123456), and the billing amount 422. The screen 420 also shows the minimum amount 424 that must be paid by a certain due date 426. An interface area 428 on the screen 420 allows the user to provide payment instructions. The user enters in an amount of money to be paid in the payment amount field 430. In this example, the user has set as default that the payment should be made from payment account A 52, and that the payment should be made today 442. It can be appreciated that the user may just as easily set the default so that payments are usually made from payment account B 53, and that the payments should be made one day before the due date 426 of the minimum payment. If the amount of money shown in the amount filed 430 is greater than the minimum amount 424, then an indicator 434 is displayed showing that at least the minimum amount of money will be paid. In one embodiment of the GUI, the indicator 434 may take the form of a check mark displayed in a check box. It can be understood that any other GUI for conveying similar information is applicable to the principles described herein.

Once the instructions have been provided, in this case namely the amount of money in field 430, the user may choose to authorize payment by selecting, clicking or hitting the authorize button 432. Alternatively, the user may wish to customize the payment instructions by selecting the customize button 438.

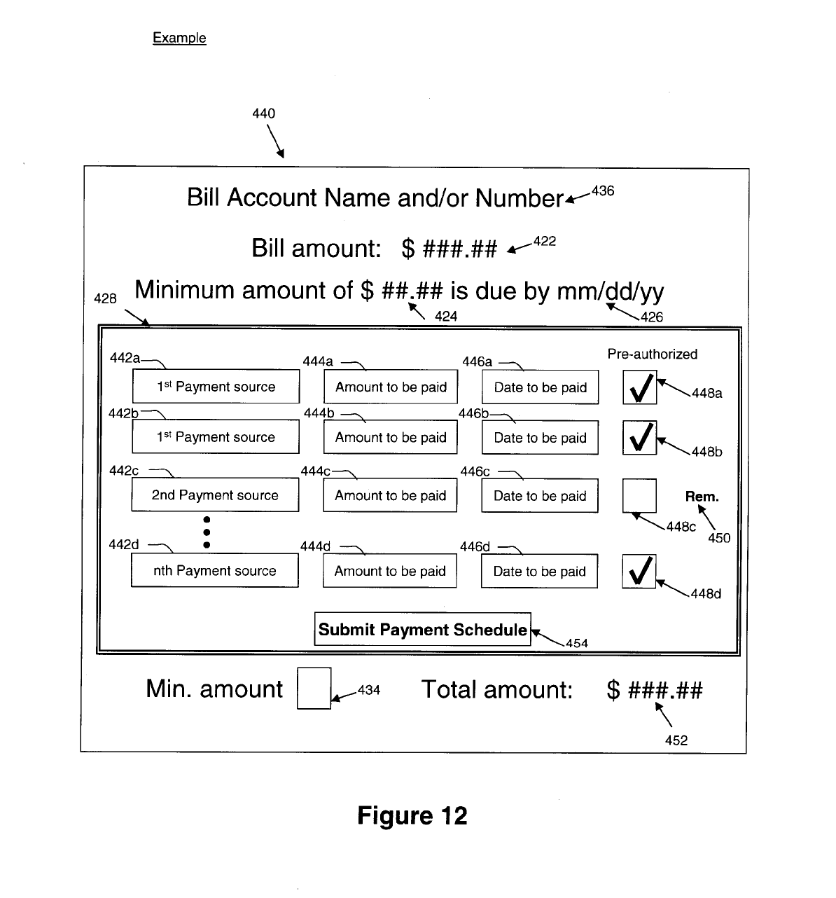

Selecting the customize button 438 invokes the mobile device 10 to display a more advanced options screen, such as the advanced options screen 440 shown in FIG. 12. The interface area 428 in FIG. 12 shows a number of options for payment, including which payment account 442 should be used, the amount to be transferred from each of the selected payment accounts 444, and the scheduled date 446 for which the payment should be made. There is also an option for determining whether there is pre-authorized payment 448, which may have a perceived advantage for any payments made in the future, as will be described in further detail below. Each entry for the payment accounts 442, amount to be paid 444, date to be paid 446, and pre-authorized payment 448 is further identified by an alphabetic suffix.

In FIG. 12, a user may specify a first payment account 442a, the amount to be paid 444a from the first payment account, and the date at which the amount is to be paid 446a. As a default, for example, the pre-authorized payment selection 448a is selected and is symbolically represented with the presence of a check mark. However, the user may choose to de-select or disable the pre-authorized payment 448 through the GUI. Pre-authorizing the payment allows the mobile device 10 via the authorization server 18, or the authorization server 18 directly, to instruct the payment server 42 to make a payment at the future scheduled date (e.g. date 446a) without notifying or requesting the user for authorization. It can be appreciated that the same payment source, for example the first payment source, may be selected again in another payment account entry 442b, whereby a different amount 444b, or a different date 446b, or both, are selected. It can be appreciated that any number of payment account entries (e.g. 442c, 442d), each having their own payment amounts (e.g. 444c, 444d), payment dates (e.g. 446c, 446d) and pre-authorization options (e.g. 448c, 448d) are available for the user's selection.

It is noted that when the user may not wish to have the bill payment pre-authorized, as per option 448c. In such a case, the mobile device 10 will notify the user with a reminder on the scheduled date 446c, to request authorization and/or confirmation of the scheduled payment. This allows the user to schedule payments for later dates while still providing the user with control of the payments before they actually occur.

A total amount indicator 452 displays the total amount of money that has been scheduled for payment towards the billing account. The user may advantageously use this information to keep track of how much money should be scheduled for payment from the various payment accounts, in view of the bill amount 422.

Once the payment amounts have been scheduled, the user may select or click on the ‘submit payment schedule’ button 454, thereby saving the payment schedule in the scheduling database 62. It can be appreciated that the payment scheduling data (e.g. the payment instructions) may also be sent to and stored on the authorization server 18. The mobile billing manager 60 will then execute the payment instructions based on the payment schedule, using the principles described generally in FIGS. 9 and 10.

In the GUI's displayed herein, any number of user interfacing mechanisms may be used, including but not limited to drop down lists, lateral scrolling lists, scroll bars, auto text complete, single clicks, double clicks, hovering functions, pop-up calendars, touch screen interfaces, scrolling balls or scroll wheels.

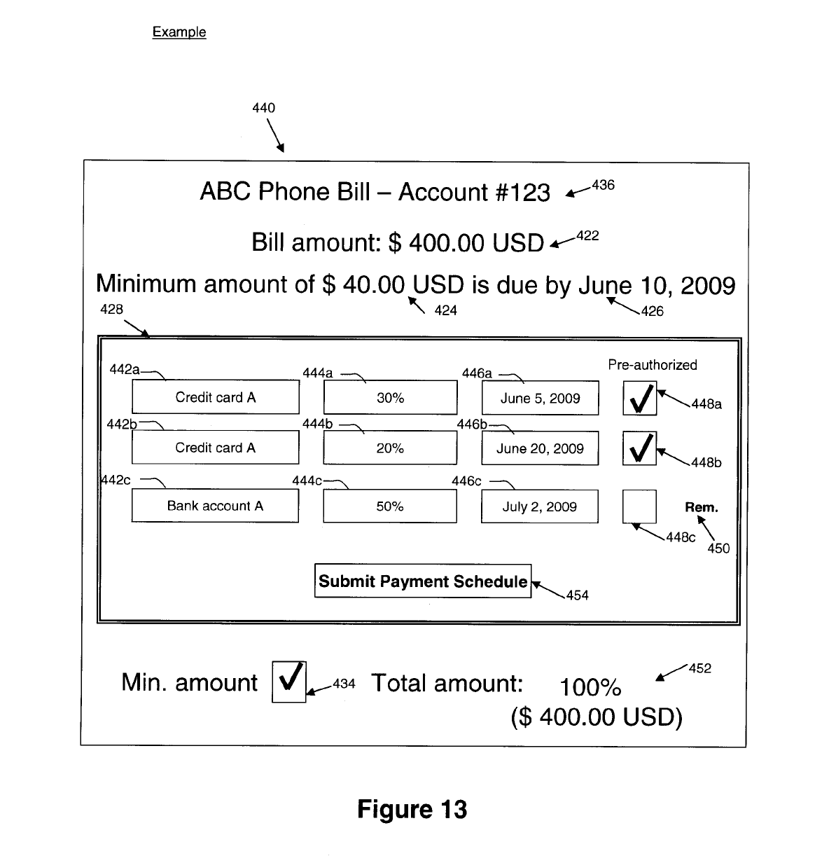

FIG. 13 shows a specific example of an advanced options screen 440. In the specific example, the bill account information 436 is displayed as “ABC Phone Bill—Account No. 123”. The bill is in the amount of $400.00 (422) and is indicated in U.S. dollars. It is noted that the currency setting may be changed according the user's preference. A minimum amount of $40.00 (424) must be paid no later than the due date 426 of Jun. 10, 2009. The user has decided to make three payments scheduled on different dates, namely Jun. 5, 2009 (446a), Jun. 20, 2009 (446b) and Jul. 2, 2009 (446c). The payments made in June are done so from credit card A (442a, 442b). The payment amount 444 may be represented in dollar amounts, or as a percentage of the amount being billed 422. The payment (444a) scheduled for June 5^{th} is set for 30% of the $400.00, while the payments scheduled for June 20^{th} and July 2^{nd} are set for 20% (444b) and 50% (444c), respectively. It is noted that the payment made on July 2^{nd} will be made from bank account A (442c) and that the user has not pre-authorized payment (448c), while the payments scheduled for June have been pre-authorized (448a, 448b). Therefore, on July 2^{nd}, the user will receive a reminder on the mobile device 10 asking the user to authorize the previously scheduled payment of 50% of $400 from bank account A (442c) to the ABC Phone Bill—Account #123 (436). Furthermore, since 30% of $400 will be paid on Jun. 5, 2009, before the due date of June 10^{th}, the minimum amount indicator 434 is automatically checked off. The total amount indicator 452 shows that 100% of the billed amount has been scheduled for re-payment.

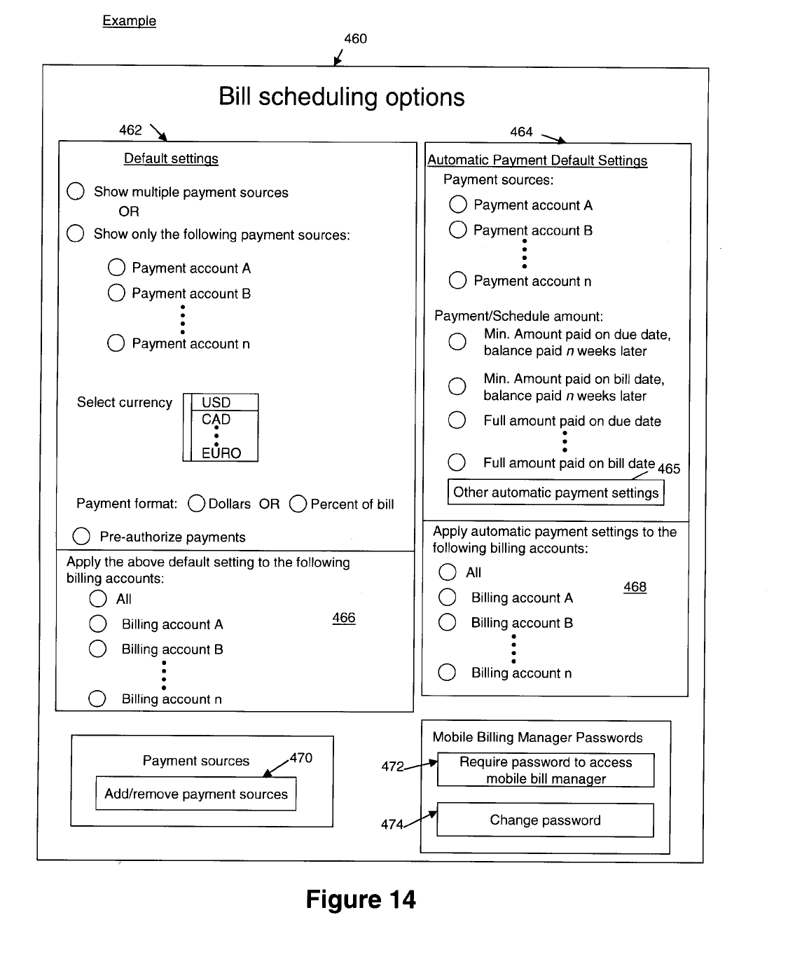

Turning to FIG. 14, an example of a bill scheduling options screen 460 is shown, which allows a user to customize default behaviour or settings of the mobile billing manager 60. It is known that various configurations of the screen, or screens, that allow a user to customizer various options are applicable to the principles described herein. The billing options screen 460 includes a default settings area 463 and an automatic payment settings area 464. The default setting area 463 shows various default settings, including whether all the user's payment accounts should be displayed, or whether a subset of the user's payment accounts should be displayed. The user can also determine the currency that the billing format is in, as well as whether the payment format is displayed in dollars or percent of the bill. The user can also specify whether payments should be pre-authorized by default. The user can also specify which of the default settings apply to all or certain of the billing accounts, as per selection area 466.

Continuing with FIG. 14, the billing options 460 also allows the user to customize the automatic payment settings using the interface in area 464. These automatic payment settings are used to determine the way in which the automatic payments are made, as described earlier with respect to block 290. The automatic payment settings may include which of the payment accounts are to be used, and the scheduling of the payments. Non-limiting examples of payment amounts and schedules include the following: the minimum amount of the bill is to be paid on the date that the bill is received; the minimum amount of the bill is to be paid on the due date; the full amount of the bill is to be paid on the date that the bill is received; and, the full amount of the bill is to be paid on the due date. The automatic payment option may be applied to one or more of the billing accounts, as shown in interface area 468. Thus, if the user has applied the automatic payment setting to billing account A 56, then the authorization server 18 will automatically command the payment server 42 to make payments to the billing server 26.

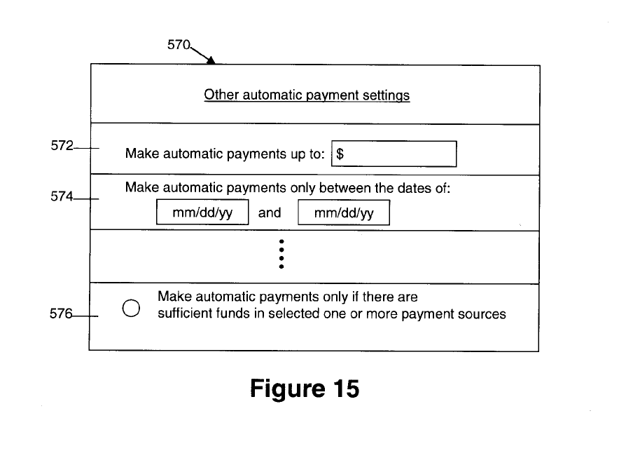

It can be appreciated that there may be other automatic payment settings. In the example GUI, when the user provided a selection input associated with the “other automatic payment settings” button 465, the mobile device 10 displays another screen 570, shown in FIG. 15. On the screen 570, a maximum amount option 572 is provided, which allows a user to determine the maximum amount that the billing manager 60 is able to automatically pay for a bill. A date option 574 allows the user to determine a date range in which automatic payments are allowed. Additionally, a sufficient funds option 576 may be enabled by the user, whereby if it is enabled, the billing manager 60 would only make automatic payments if there are sufficient funds in the selected one or more payment sources.

Turning back to FIG. 14, the billing options 460 also includes an ‘add/remove payment sources’ button 470 that allows a user to enter into a process of adding or removing payment sources from the list. The addition of a payment account or source may include registering pre-authorized access to a payment server 42.

There may also be a password option, in which a password may be required for using the mobile billing manager 60 application, as per button or selection 472. The user may also change the password using the button or selection 474.

The above described defaults settings and option settings are stored in the default settings database 68.

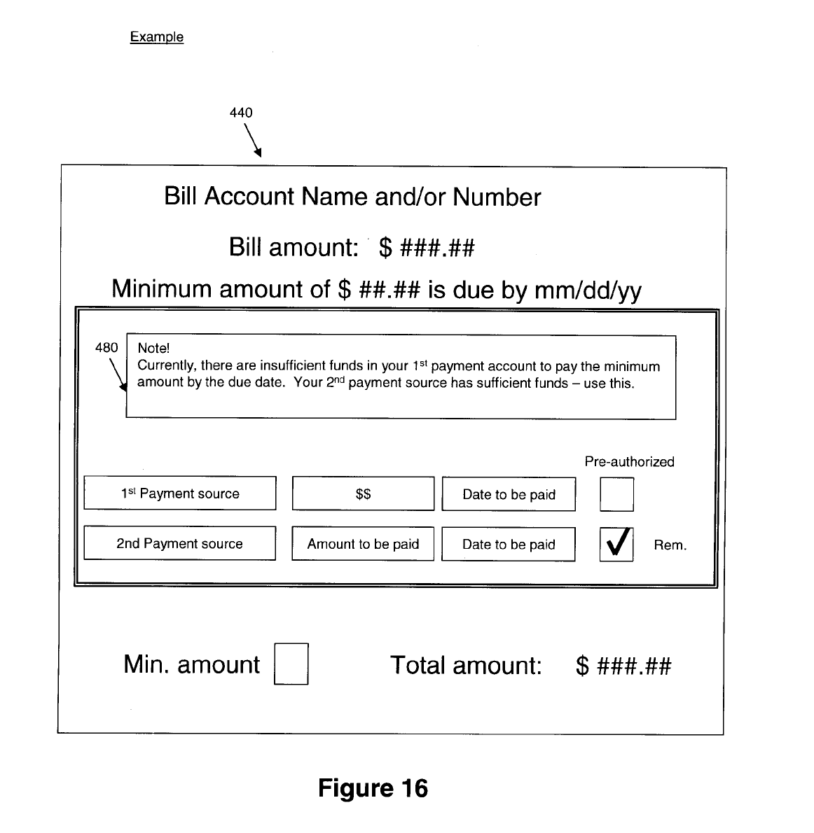

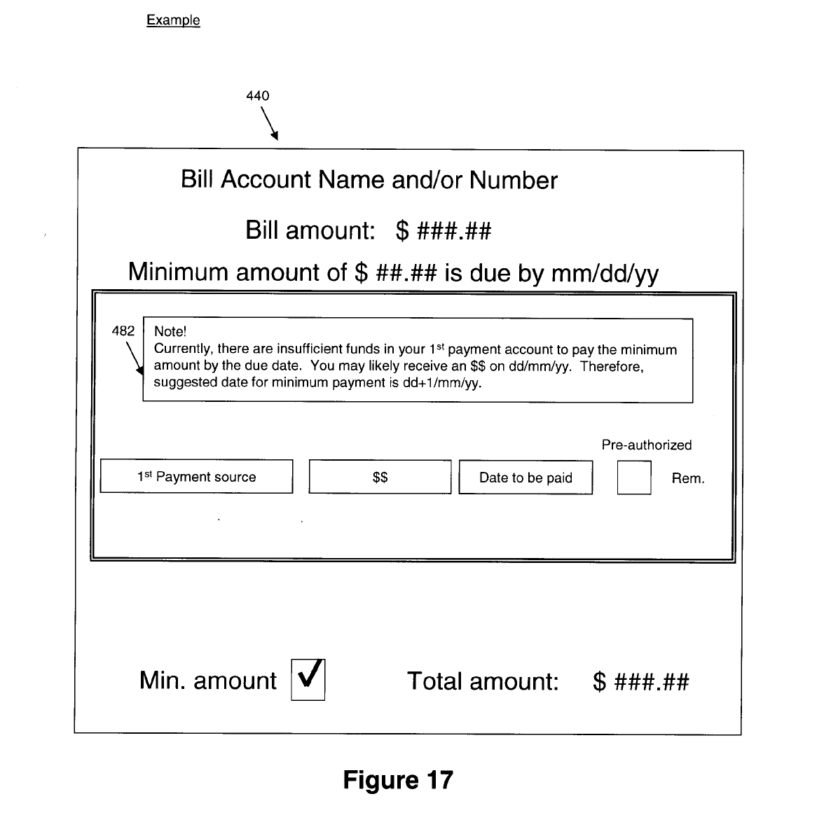

Turning to FIGS. 16 and 17, as described earlier, there may be a number of payment and scheduling rules stored in the payment/scheduling rules database 66. In FIG. 15, a user attempts to pay a bill from a first payment account. However, based on a rule, the authentication server 18 retrieves the amount of available funds in the first payment account and determines whether or not there are sufficient funds. If there are insufficient funds, the authorization server 18 notifies the mobile device 10 that there currently are insufficient funds to pay the minimum amount. This notification is displayed in the message alert 480. Then, based on the rule, the mobile billing manager 60 determines which of the payment accounts have sufficient funds for paying the minimum amount and suggests the user to make a payment from such payment accounts. Alternatively, in an automatic payment process, the mobile billing manager 60 would automatically instruct the authorization server 18 to make a minimum payment from the payment account that has sufficient funds. In the example shown in FIG. 16, although the first payment account does not have sufficient funds, the second payment account does have sufficient funds for paying the minimum amount.

In FIG. 17, a similar scenario is applied, where the first payment account does not have sufficient funds. However, the authorization server 18 accesses the payment server 42 to estimate or predict the schedule of incoming funds or money patterns of the first payment account. In other words, if every two weeks an amount $1,000 is deposited into the first payment account, for example, for a bi-weekly salary, then the authorization server 18 can estimate the date at which there will be a scheduled deposit of money or funds into the first payment account. Once an estimated date and estimated amount is determined and sent to the mobile billing manager 60, a rule will determine when the payment of the minimum amount using the first payment account should be made. For example, the mobile billing manager 60 will suggest, or automatically execute, a payment of the minimum amount to be made three days after the estimated payment date. The suggestion is shown in the notification 482 in FIG. 17.

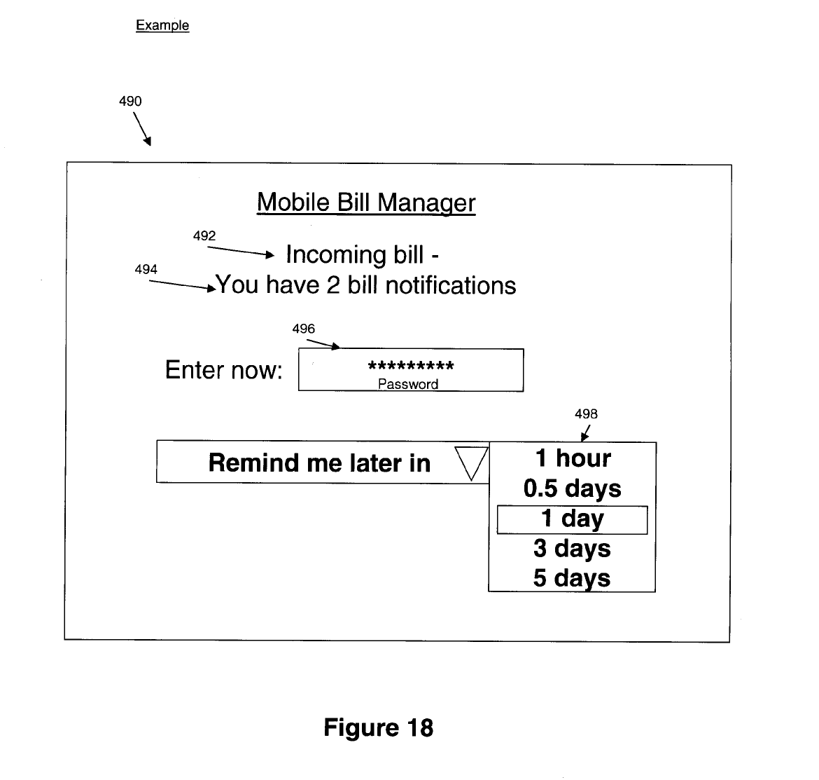

Turning to FIG. 18, a notification screen 490 for the mobile billing manager 60 is shown. This screen appears when the user would like to access the mobile billing manager 60, or appears automatically on the display 110 of the mobile device 10 when there is an incoming notification, either scheduled or non-scheduled. For example, when a bill is sent from a billing server 26, via the authorization server 18, to the mobile device 10, the mobile billing manager 60 alerts the user with such a screen 490. The screen 490 will show there is an incoming bill 492, as well as any other unread bill notifications 494. If the user has set-up a password to access the mobile billing manager 60, there may be a password field 496 for the user to enter the password. If the user does not want to address or schedule the bill payment upon receiving the bill, the user can defer the scheduling and payment to a later date or time. The user can, for example, select how many hours or days before the mobile billing manager 60 issues a reminder to schedule a payment for the bill through a drop-down selection menu 498. The screen 490 may be shown, for example, at blocks 280 or 284, as described in regards to FIG. 9. The reminder date is stored in the activities schedule 256, which may be stored in the scheduling database 62.

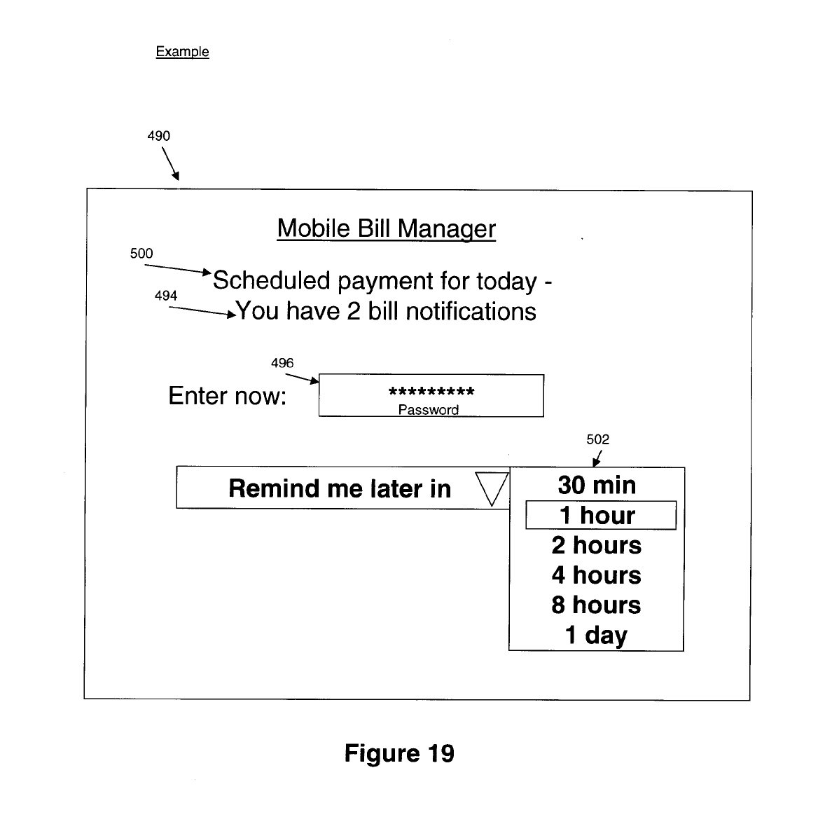

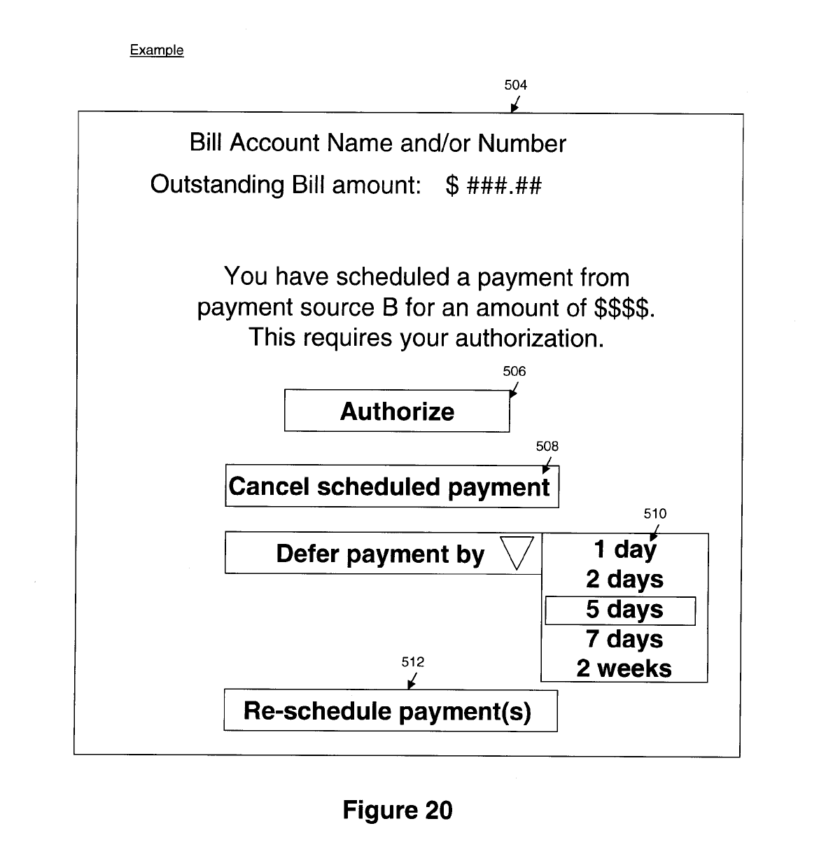

Turning to FIG. 19, another notification screen 490 is shown, displaying that there is a scheduled payment for today 500. It can be appreciated that, as described above, the user may choose to schedule a payment at a future date without pre-authorizing the payment. Thus, on the scheduled future date, a notification appears alerting the user that ‘today’ a payment is scheduled and then requests the user to authorize the previously scheduled payment. A deferral option 502 is also presented to the user. However, it is noted that the deferral options preferably comprise shorter time periods in the range of several hours in order to reduce the delay in bill payment. Upon receiving the notification screen 490, the user may invoke other functions of the mobile billing manager 60 to address the scheduled payment for ‘today’. The user, for example, may enter a password in the password field 496 to invoke those other billing manager functions. Doing so may invoke an authorization screen 504 shown in FIG. 20.

The screen 504 in FIG. 20 displays the bill account name or number, or both, and the outstanding balance or bill amount. The screen 504 also displays the scheduled payment activity that requires authorization. For example a message may read that “You have scheduled a payment from payment account B for an amount of $$$$ on today's date.” The user may then simply select or hit the ‘authorize’ option or button 506, thereby authorizing the payment. Thus, based on this payment instruction, the mobile device 10 will send the payment instructions and any required credentials, or parts thereof, to the authorization server 18. As described above, the authorization server 18 will instruct the payment server 42 to make the payment. Alternatively the user can cancel the scheduled payment 508, or defer the payment by some amount of time 510. The user may also wish to re-schedule any one of the payment date, payment amount, payment account, or combinations thereof. By selecting the re-scheduling option 512, the user may be presented with an advanced bill scheduling screen 440 particular to the specified billing account, as described earlier.

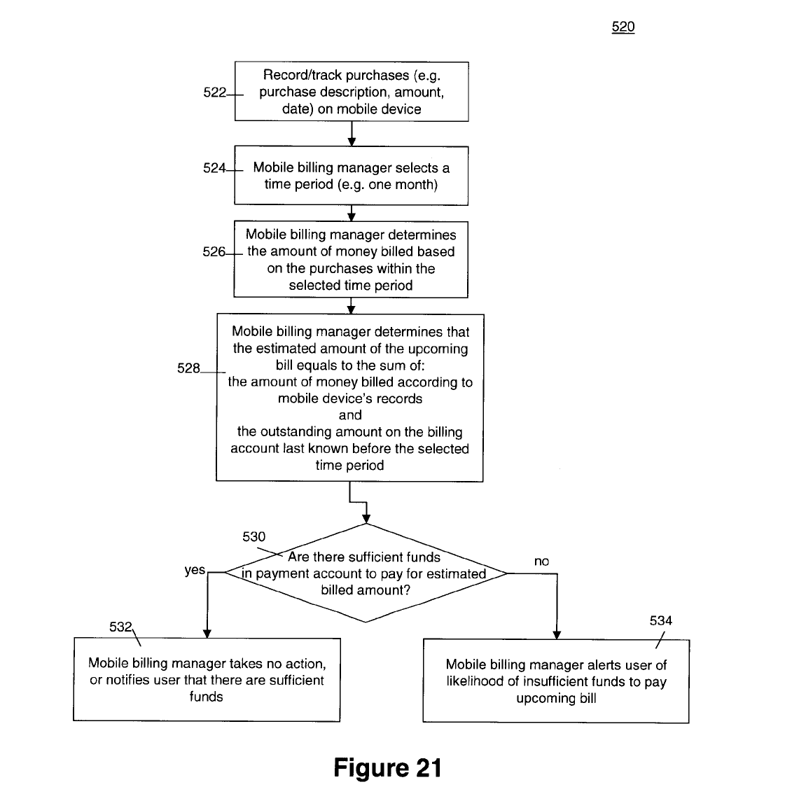

In another embodiment of the bill payment and scheduling system and method, a system and method are provided for estimating future bill payments and verifying purchases on a bill. Turning to FIG. 21, a method 520 for estimating the upcoming billed amount is shown. The mobile device 10 may track or record the purchases made on a certain billing account (block 522). A user may manually enter in the purchase information (e.g. description of purchase, amount of money, and date) into the mobile device 10. Alternatively, in some mobile applications, purchases are executed or authorized through a mobile device 10. By way of background, such mobile applications are commonly referred to as mobile wallets. This may be typical of credit purchases that are authorized or executed using a mobile device 10. In such mobile wallet applications, the purchase information may be recorded. Then, at block 524, the mobile billing manager 60 selects a time period, such as for example, a month. At block 526, the mobile billing manager 60 determines the amount of money billed within the selected time period by summing or totalling the amount of money of the purchases, whereby the each of the purchases have a corresponding date within the selected time period. Then, the mobile billing manager 60 determines the estimated amount of the upcoming bill from the billing server 26 by taking the sum of the estimated total amount of purchases and the last known outstanding balance predating the selected time period, which can be obtained from the previous bill (block 528). The mobile billing manager 60 may use the estimated billing amount to determine if there are sufficient funds in one or more of the specified payment accounts to pay for the estimated bill amount (block 530). It can be appreciated that the authorization server 18 would need to have pre-authorized access to the payment server 42 to retrieve information regarding the available amount of funds in the payment account, and that the authorizations server 18 would send this information to the mobile device 10. In this way, the mobile billing manager 60 would have the information needed to make the determination described in block 530. If there are insufficient funds, then the mobile device 10 notifies the user that there is high possibility or likelihood that there are insufficient funds to pay the upcoming bill (block 534). If there are likely to be sufficient funds, then the mobile billing manager 60, through the mobile device 10, may take no action or notify the user there will likely be sufficient funds for the upcoming bill payment (block 532).

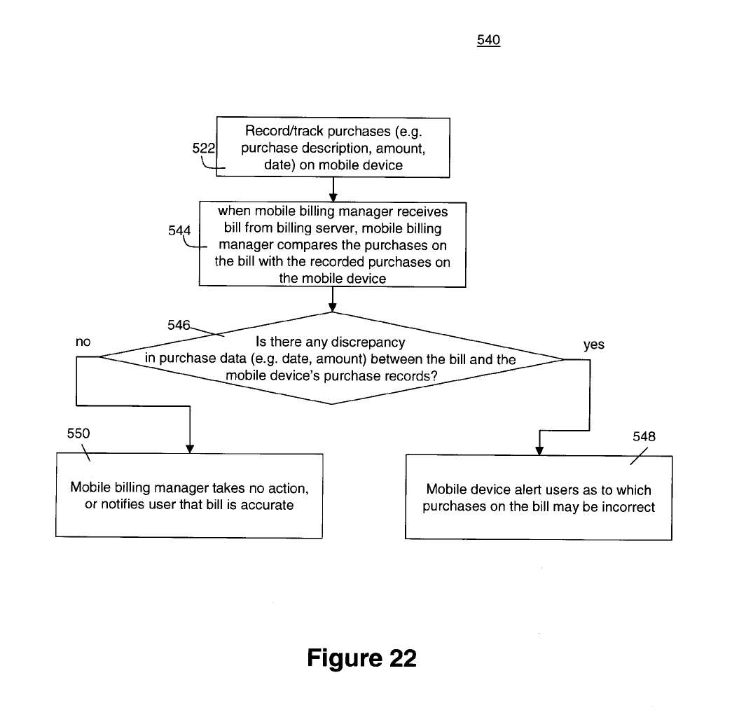

In another method that uses the tracked purchase data from block 522, FIG. 22 shows a method 540 for verifying that the billing data is correct. After collecting the purchase data at block 522, the mobile billing manager 60 receives a bill from the billing server 26, via the authorization server 18. Upon receiving the bill, the mobile billing manager 60 compares the purchases on the bill with the recorded purchases on the mobile device 10 (block 544). If there is any discrepancy in the purchase data (e.g. date, amount of money) between the bill and the mobile device's purchases records (block 546), then the mobile billing manager 60, through the mobile device 10, alerts the user to the possibly incorrect purchases on the bill (block 548). If the bill is accurate, then no action is taken or the mobile device 10 notifies the user that the bill is accurate (block 550). This advantageously allows the user to verify bill statements.

In another embodiment, the billing server 26 may provide a bill based on a certain threshold billing amount. In other words, when the billing amount exceeds a threshold amount, then the billing server 26 will send the bill to the authorization server 18.

It can thus be appreciated that the combination of a bill payment and scheduling system on a mobile device, as described above, advantageously allows the user to schedule and coordinate bill payments. Furthermore, the such a system advantageously reduces the amount of time required to make bill payments, while maintaining the security of the data.

The billing entities who manage the billing accounts also advantageously receive bill payments more quickly from the users, since a comprehensive reminder and scheduling system is provided in the above-described system and method.

The steps or operations in the flow charts described herein are just for example. There may be many variations to these steps or operations without departing from the spirit of the invention. For instance, the steps may be performed in a differing order, or steps may be added, deleted, or modified.

While the basic principles of this invention has been herein illustrated along with the embodiments shown, it will be appreciated by those skilled in the art that variations in the disclosed arrangement, both as to its details and the organization of such details, may be made without departing from the spirit and scope thereof. Accordingly, it is intended that the foregoing disclosure and the showings made in the drawings will be considered only as illustrative of the principles of the invention, and not construed in a limiting sense.

1. A system for scheduling the payments of one or more bills comprising:
an authorization server in communication with one or more payment servers and a mobile device, the authorization server configured to receive one or more bills from a billing account, and the one or more payment servers each configured to make one or more payments to the billing account;
a mobile billing manager residing on at least the mobile device, the mobile billing manager configured to execute the following instructions:
displaying a graphical user interface (GUI) on the mobile device to receive one or more selection inputs to activate and determine automatic payment settings associated with one or more payment accounts, one or amounts to be paid, and one or more respective payment dates associated with each of the one or more amounts to be paid;
upon the mobile billing manager detecting the receipt of a bill, the mobile billing manager, through the authorization server, instructing the one or more payment servers to pay a first amount at a first predetermined date from a first payment account.

2. The system according to claim 1 wherein the mobile billing manager also resides on the authorization server.

3. The system according to claim 1 wherein upon detecting the receipt of a bill, the mobile billing manager on the authorization server does not communicate with the mobile device before instructing the one or more payment servers to automatically pay the first amount.

4. The system according to claim 1 wherein the bill comprises a total amount billed and a requested minimum amount to be paid by a due date.

5. The system according to claim 4 wherein the GUI for the automatic payment settings includes an option for setting the first predetermined date to be on or before the due date and the first amount to be greater than or equal to the requested minimum amount.

6. The system according to claim 1 wherein the GUI for the automatic payment settings allows a user to determine the maximum amount to be automatically paid in association with the bill.

7. The system according to claim 1 wherein the automatic payment settings are activated for a given range of dates.

8. The system according to claim 1 wherein the mobile manager is also configured to execute instructions for:
determining the available amount of funds in the first payment account;
determining if the available amount of funds are greater than the first amount and, if so, instructing the payment server to pay the first amount.

9. The system according to claim 1 wherein the mobile billing manager further instructing the one or more payment servers to pay a second amount at a second predetermined date from the first payment account or a second payment account for the bill.

10. The system according to claim 4 wherein the mobile billing manager further instructing the one or more payment servers to pay a second amount at a second predetermined date from the first payment account or a second payment account, and wherein the second amount is the balance of the total amount billed that is unpaid and the second date is after the first predetermined date.

11. The system according to claim 9 wherein a first payment server is associated with the first payment account and a second payment server is associated with the second payment account.

12. The system according to claim 9 wherein the second amount is scheduled to be paid on the second predetermined date from the second account.

13. A method for scheduling the payments of one or more bills comprising:
an authorization server in communication with one or more payment servers and a mobile device, the authorization server configured to receive one or more bills from a billing account, and the one or more payment servers each configured to make one or more payments to the billing account;
a mobile billing manager residing on at least the mobile device, the mobile billing manager configured to execute the following instructions:
displaying a graphical user interface (GUI) on the mobile device to receive one or more selection inputs to activate and determine automatic payment settings associated with one or more payment accounts, one or amounts to be paid, and one or more respective payment dates associated with each of the one or more amounts to be paid;
upon the mobile billing manager detecting the receipt of a bill, the mobile billing manager, through the authorization server, instructing the one or more payment servers to pay a first amount at a first predetermined date from a first payment account.

14-24. (canceled)

25. A system for scheduling the payments of one or more bills comprising:
an authorization server in communication with one or more payment servers and a mobile device, the authorization server configured to receive one or more bills from a billing account, and each of the one or more payment servers configured to make one or more payments to the billing account;
a mobile billing manager residing on at least the mobile device, the mobile billing manager configured to execute the following instructions:
upon the mobile billing manager detecting a bill, displaying a graphical user interface (GUI) on the mobile device;
receiving one or more selection inputs through the GUI associated with paying a first amount at a first predetermined date from a first payment account; and
the mobile billing manager, through the authorization server, instructing the one or more payment servers to pay the first amount at the first predetermined date from the first payment account.

26. The system according to claim 25 wherein the bill comprises at least any one of a new bill or an outstanding bill.

27. The system according to claim 25 wherein the mobile billing manager also resides on the authorization server.

28. The system according to claim 25 wherein the bill comprises a total amount billed and a requested minimum amount to be paid by a due date.

29. The system according to claim 28 wherein the mobile billing manager displays an option box that is checked off when at least the requested minimum amount is scheduled to be paid on or before the due date.

30. The system according to claim 25 wherein the mobile billing manager is also configured to execute the following instructions:
through the GUI, the mobile billing manager displaying an option of whether or not to pre-authorize the authorization server to automatically instruct the one or more payment servers to pay the first amount; and,
if the first amount is not pre-authorized, then on or before the first predetermined date, the mobile billing manager displaying on the mobile device a request for authorization to pay the first amount from the first payment account.

31. The system according to claim 25 wherein the mobile billing manager is also configured to execute instructions for:
determining from the one or more payment servers the available amount of funds in the first payment account;
determining if the available amount of funds are greater than the first amount and, if so, instructing the one or more payment servers to pay the first amount.

32. The system according to claim 31 wherein if the available amount of funds are not greater than the first amount, then the mobile billing manager displaying a notification that there are insufficient funds in the first payment account.

33. The system according to claim 32 wherein the mobile billing manager is also configured to execute instructions for:
determining which one of the one or more payment accounts has available funds that are greater than the first amount;
displaying on the mobile device a suggestion to pay the first amount from the one of the one or more payment accounts that has available funds greater than the first amount

34. The system according to claim 25 wherein the mobile billing manager is also configured to execute instructions for:
receiving the one or more selection inputs through the GUI associated with paying a second amount at a second predetermined date from the first payment account or a second payment account; and,
the mobile billing manager, through the authorization server, further instructing the one or more payment servers to pay the second amount at the second predetermined date from the first payment account or the second payment account.

35. The system according to claim 28 wherein the mobile billing manager is also configured to execute the following instructions:
receiving the one or more selection inputs through the GUI associated with paying a second amount at a second predetermined date from the first payment account or a second payment account;
the mobile billing manager, through the authorization server, further instructing the one or more payment servers to pay the second amount at the second predetermined date from the first payment account or the second payment account; and,
upon receiving the one or more selection inputs associated with paying the first amount and the second amount, the mobile billing manager determining and displaying on the GUI whether or not at least the requested minimum amount is scheduled to be paid on or before the due date.

36. The system according to claim 34 wherein a first payment server is associated with the first payment account and a second payment server is associated with the second payment account.

37. The system according to claim 34 wherein the second amount is scheduled to be paid on the second predetermined date from the second account.

38. The system according to claim 34 wherein the mobile billing manager is also configured to execute the following instructions:
through the GUI, the mobile billing manager displaying an option of whether or not to pre-authorize the authorization server to automatically instruct the one or more payment servers to pay the second amount;
if the second amount is not pre-authorized, then on or before the second predetermined date, the mobile billing manager displaying on the mobile device a request for authorization to pay the second amount from the first payment account or the second payment account.

39. A method for scheduling the payments of one or more bills comprising:
an authorization server in communication with one or more payment servers and a mobile device, the authorization server configured to receive one or more bills from a billing account, and each of the one or more payment servers configured to make one or more payments to the billing account;
a mobile billing manager residing on at least the mobile device, the mobile billing manager configured to execute the following instructions:
upon the mobile billing manager detecting a bill, displaying a graphical user interface (GUI) on the mobile device;
receiving one or more selection inputs through the GUI associated with paying a first amount at a first predetermined date from a first payment account; and
the mobile billing manager, through the authorization server, instructing the one or more payment servers to pay the first amount at the first predetermined date from the first payment account.

40-54. (canceled)
